(19) United States
(12) Patent Application Publication
(10) Pub. No.: US 2019/0069014 A1
(43) Pub. Date: Feb. 28, 2019

(54) CONTENT DISTRIBUTION DEVICE, CONTENT DISTRIBUTION SYSTEM, AND STORAGE MEDIUM

(71) Applicant: SHARP KABUSHIKI KAISHA, Sakai City (JP)

(72) Inventor: KATSUYASU FURUKAWA, Sakai City (JP)

(21) Appl. No.: 16/107,086

(22) Filed: Aug. 21, 2018

(30) Foreign Application Priority Data
Aug. 24, 2017 (JP) 2017-161407

(51) Int. Cl. H04N 21/262; G06F 17/30; H04N 21/218

(52) U.S. Cl. CPC H04N 21/26258; H04N 21/218; G06F 17/30091; G06F 17/30115

(57) ABSTRACT

A content distribution device connectable to a display device that displays a content includes a management unit that manages, as a content folder, a content to be distributed to the display device, a directory assignment unit that assigns a directory in which the content is stored to the content folder, and a content distribution unit that distributes, to the display device, the content stored in the directory assigned to the content folder.

### BACKGROUND

### 1. Field

The present disclosure relates to a content distribution device and the like.

### 2. Description of the Related Art

In recent years, digital signage is widely used. In the digital signage, a display device is disposed in a place where there are many people, such as a station or a shopping center, and contents such as advertisements are displayed on the display device.

For example, Japanese Unexamined Patent Application Publication No. 2016-200892 and Japanese Unexamined Patent Application Publication No. 2017-55419 disclose a technique in which a content is displayed in accordance with a schedule on a display device which is a signage terminal.

In general, digital signage systems have been developed with focus on availability and maintainability in terms of the characteristics of the system. Since distribution of contents itself is executed by an administrator side and the contents are not frequently updated, convenience has not been taken into consideration for a system on the content distribution side. Therefore, in the case of storing contents, the administrator stores the contents one by one, or in the case of setting a time schedule, the administrator usually inputs commands and the like.

However, with the digital signage being widely used in recent years, there have been various desires as the number of panels as display devices increases or the size of the system increases. For example, there are a desire for selling a frame with a display time zone specified as an advertisement frame and a desire for displaying different contents for different regions.

However, as described above, since the convenience is not taken into consideration in a content distribution device of the related art, when trying to utilize the device in response to the desires, problems such as poor usability have arisen.

It is desirable to provide a highly convenient content distribution system and the like that may easily specify a content to be distributed.

### SUMMARY

A content distribution device according to an aspect of the present disclosure is connectable to a display device that displays a content. The content distribution device includes a management unit that manages, as a content folder, the content to be distributed to the display device, a directory assignment unit that assigns a directory in which the content is stored to the content folder, and a content distribution unit that distributes, to the display device, the content stored in the directory assigned to the content folder.

A content distribution device according to another aspect of the present disclosure is connectable to a display device that displays a content. The content distribution device includes a management unit that manages the content as a content folder, a directory assignment unit that assigns a directory in which the content is stored to the content folder, a program information generation unit that generates program information indicating a layout for displaying the content on the display device in accordance with the content folder, a display schedule information generation unit that sets a display schedule for displaying the content on the display device and generates display schedule information in accordance with the content folder or the program information, a display device assignment unit that assigns distribution data including the content to the display device in accordance with any one of the content, the content folder, the program information, and the display schedule information, and a distribution unit that distributes the distribution data assigned by the display device assignment unit to the assigned display device.

A content distribution system according to still another aspect of the present disclosure includes a display device that displays a content and a content distribution device connectable to the display device. The content distribution device includes a management unit that manages, as a content folder, a content to be distributed to the display device, a directory assignment unit that assigns a directory in which the content is stored to the content folder, and a content distribution unit that distributes, to the display device, the content stored in the directory assigned to the content folder, and the display device includes a content reception unit that receives the content distributed from the content distribution device and a content display unit that displays the received content.

A non-transitory storage medium stores a program according to further another aspect of the present disclosure causing a computer connectable to a display device that displays a content to executes a management function of managing, as a content folder, the content to be distributed to the display device, a directory assignment function of assigning a directory in which the content is stored to the content folder, and a content distribution function of distributing, to the display device, the content stored in the directory assigned to the content folder.

### BRIEF DESCRIPTION OF THE DRAWINGS

FIG. 1 is a diagram for describing an overview of a content distribution system in a first embodiment;

FIG. 2 is a diagram for describing a concept of a content folder according to the first embodiment;

FIG. 3 is a diagram for describing a functional configuration of a content distribution device according to the first embodiment;

FIG. 4A is a diagram for describing a play list, FIG. 4B is diagram for describing program information, and FIG. 4C is diagram for describing schedule information in the first embodiment;

FIG. 5 is a diagram for describing a functional configuration of a display device in the first embodiment;

FIG. 6 is a diagram for describing content distribution processing in the first embodiment;

FIG. 7 is a diagram for describing an operation example (content folder creation) in the first embodiment;

FIGS. 8A and 8B are diagrams for describing an operation example (directory assignment) in the first embodiment;

FIG. 9 is a diagram for describing an operation example (content folder assignment) in the first embodiment;

FIG. 10 is a diagram for describing an operation example (content folder assignment) in the first embodiment;

FIG. 11 is a diagram for describing an operation example (content folder assignment) in the first embodiment;

FIG. 12 is a diagram for describing content distribution processing in a second embodiment;

FIG. 13 is a diagram for describing an operation example (content folder creation) in the second embodiment;

FIG. 14 is a diagram for describing an operation example (content upload) in the second embodiment;

FIG. 15A is a diagram for describing an operation example of setting of an attribute of a content, and FIG. 15B is a diagram for describing an operation example of setting of display restriction information in the second embodiment;

FIG. 16 is a diagram for describing content distribution processing in a third embodiment;

FIG. 17 is a diagram for describing an operation example (display layout creation) in the third embodiment;

FIG. 18 is a diagram for describing an operation example (display layout creation) in the third embodiment;

FIG. 19 is a diagram for describing an operation example (display layout creation) in the third embodiment;

FIG. 20 is a diagram for describing content distribution processing in a fourth embodiment;

FIG. 21 is a diagram for describing an operation example (content folder assignment) in the fourth embodiment;

FIG. 22 is a diagram for describing an operation example (content folder assignment) in the fourth embodiment;

FIG. 23 is a diagram for describing an operation example (content folder assignment) in the fourth embodiment;

FIG. 24 is a screen example (content folder creation) in the second embodiment;

FIG. 25 is a screen example (content upload) according to the second embodiment;

FIG. 26 is a screen example (setting of the attributes of the content) in the second embodiment;

FIG. 27 is a screen example (setting of display restriction information) in the second embodiment;

FIG. 28 is a screen example of a content folder list screen;

FIG. 29 is a screen example (display layout creation) according to the third embodiment;

FIG. 30 is a screen example (content folder assignment) in the first embodiment;

FIG. 31 is a screen example (content folder assignment) in the fourth embodiment;

FIGS. 32A and 32B are screen examples (content folder assignment) according to the fourth embodiment, where FIG. 32A is an example illustrating a display format as a monthly display, and FIG. 32B is an example illustrating the display format as a daily display; and

FIGS. 33A and 33B are screen examples (directory assignment) according to the first embodiment, where FIG. 33A is a display screen of the content file assigned to the content folder, and FIG. 33B is a screen displaying a content directory as a link destination of the content folder.

### DESCRIPTION OF THE EMBODIMENTS

Hereinafter, embodiments of the present disclosure will be described with reference to drawings. In the embodiments, as an example, a content distribution system including a content distribution device according to the present disclosure will be described.

### 1. First Embodiment

### 1.1 Overall Configuration

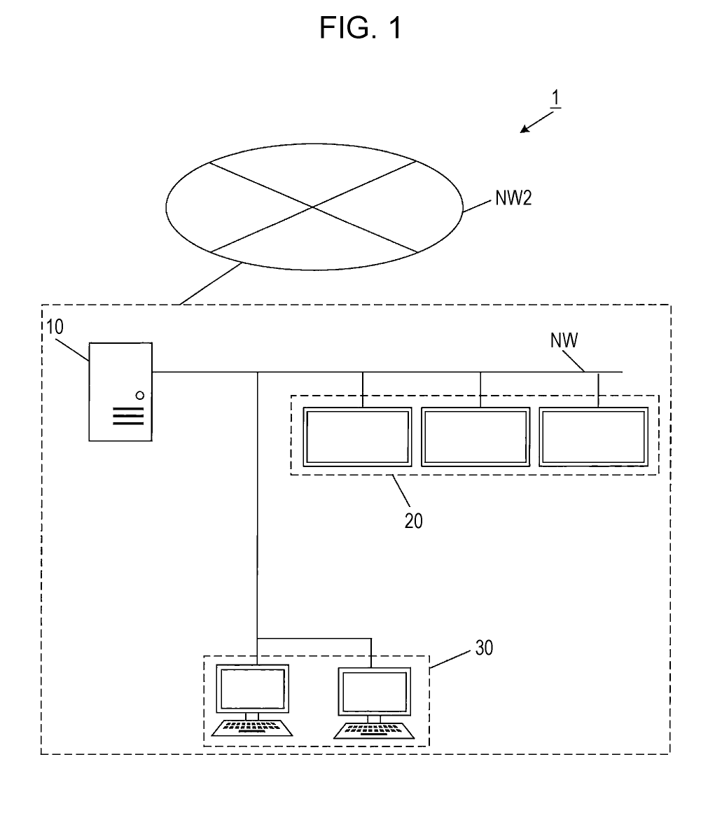

First, the overall configuration of a content distribution system 1 of the present embodiment will be described with reference to FIG. 1. As illustrated in FIG. 1, the content distribution system 1 is connected to a content distribution device 10, one or more display devices 20, and one or more terminal apparatuses 30 via a network NW. In addition, the content distribution device 10 is connected to an external network NW 2. As the network NW, for example, a local area network (LAN) or the like is assumed, and as the external network NW 2, for example, the Internet or the like is assumed.

The content distribution device 10 is a device that manages one or more display devices 20 connected to the network NW and distributes the content to the one or more display devices 20. For example, the content distribution device 10 provides functions for registering and distributing contents provided by content providers, information providers, and advertisement distributors.

The display device 20 is a device that displays the content distributed from the content distribution device 10 and is also referred to as a panel.

The terminal apparatus 30 may be, for example, a device such as a computer or an information processing device such as a smartphone or a tablet. That is, any terminal apparatus that may connect to the content distribution device 10 and specify uploading or distribution of the content is acceptable.

Here, the content referred to in the present embodiment is a still image, a moving image, a voice, a character, or the like and is a content that the display device 20 may output. The moving image may be a file of any moving image format such as Audio Video Interleave (AVI), Windows Media Video (WMV), MPEG, or the like. In addition, the still image may be a file of any image format such as JPEG, PNG portable network graphics (PNG), graphics interchange format (GIF), or the like.

### 1.2 Concept Description of Present Embodiment

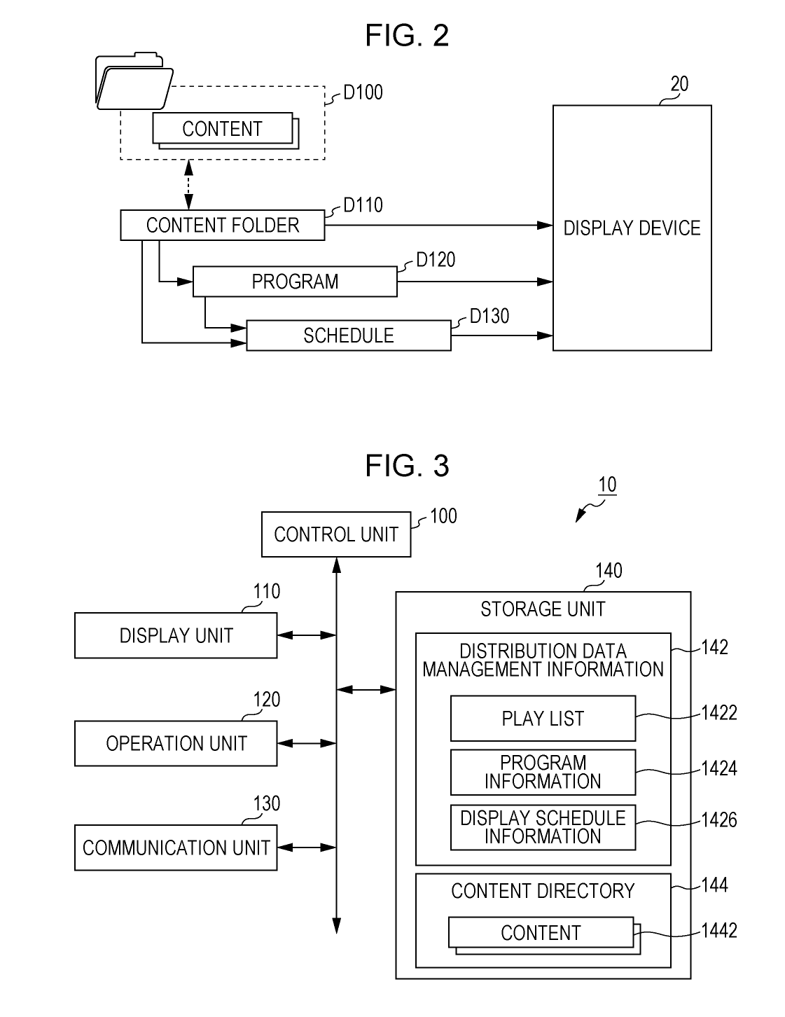

First, the basic concept of the present embodiment will be described with reference to FIG. 2. FIG. 2 illustrates the relationship between a directory D100, a content folder D110, a program D120, a display schedule D130, and a display device 20.

The directory D100 is a location where files are stored in a storage device of the content distribution device 10, and an actual content (file) is stored. The directory in the present embodiment refers to a structure in a file system and may be referred to as a folder in various OS's such as Windows and android. The directory may be a directory created on a local disk of each device such as the content distribution device 10 or may be a directory created on a network drive. In addition, the directory may be also a directory in a virtual file system generated in one file.

One or more contents stored in the directory are managed as the content folder D110. The content folder D110 manages the position (location) of the directory D100 as a link.

By using the content folder D110, one or more contents stored in the directory D100 (directory D100 shown as a link destination) assigned to the content folder D110 are referred to and distributed to the display device 20.

The display device 20 may display one or more contents. For example, contents referenced by the content folder D110 may be repeatedly displayed on the full screen in order of storage.

Then, based on the content folder D110, it is possible to assign the content folder D110 to a program or a display schedule. Here, the program D120 is information relating to a layout in the display device 20, for example. For example, a display screen is divided into right and left, upper and lower display frames. The display screen may be flexibly configured by assigning content folders and contents to each display frame.

For example, the main content folder is assigned on the left side of the display screen and the subordinate content folders on the right side. Thus, a content folder may be displayed on the left and right sides of the display screen based on the assigned display frame. A content may be directly assigned to the display frame besides the content folder.

In addition, it is also possible to assign the content folder D110 and the program D120 to the display schedule D130. That is, by assigning the content folder D110 and the program D120 to a specified date and time, the display device 20 may display the content of the content folder D110 or the program D120 at the specified date and time.

In addition, for each content folder D110, settings related to management permissions or display may be made. For example, the administrator who may edit the content in the content folder D110 (permission information) is set. In this case, the administrator without a permission may not add, overwrite, or delete the content in the content folder D110.

In addition, the content folder D110 may include settings relating to content display (display information). In this case, the content included in the content folder is displayed according to the display information. For example, “display every 10 seconds in the order in which the contents are stored” may be set as the display settings. If three files of content are stored in a content folder with such display settings, these three files are displayed every 10 seconds in the stored order.

Then, the content is distributed to the display device 20 as distribution data based on the content folder D110, the program D120, and the display schedule D130. The distribution data includes information on the content folder D110, the program D120, and the display schedule D130. These pieces of information may be separately managed or may be stored together with the directory D100 in which the contents are stored.

That is, it is possible to manage and distribute contents with the content folder D110 as a center by utilizing the system of the present embodiment. For example, by associating two or more display devices 20 with the single content folder D110, operations performed on the content folder D110 are reflected on the associated display devices 20. Therefore, it is possible to efficiently manage and distribute the contents.

### 1.3 Functional Configuration

The functional configuration of each device will be described with reference to drawings.

### 1.3.1 Content Distribution Device

A functional configuration of the content distribution device 10 according to the present embodiment will be described with reference to FIG. 3. As illustrated in FIG. 3, the content distribution device 10 includes a control unit 100, a display unit 110, an operation unit 120, a communication unit 130, and a storage unit 140.

The control unit 100 is a functional unit for controlling the entire content distribution device 10. The control unit 100 realizes various functions by reading and executing various programs stored in the storage unit 140 and is configured by, for example, a central processing unit (CPU) or the like.

The display unit 110 is a functional unit that displays a screen for registering a content and checking the status of the display device 20 to be managed. For example, the display unit 110 is constituted by a liquid crystal display (LCD), an organic EL display (OLED), an LED screen, or the like.

The operation unit 120 is a functional unit that an operator such as an administrator of the content distribution system inputs instructions and the like, and for example, may be constituted by a mouse, a keyboard, or the like connected to the content distribution device 10, or may be integrated with the display unit 110 as a touch panel.

The communication unit 130 is a functional unit for communicating with other devices. For example, the communication unit 130 may be a functional unit that may communicate via a wired LAN or a functional unit that may communicate via a wireless LAN. The communication scheme may be Ethernet (registered trademark), IEEE802.11a/b/g/n, or a communication network such as LTE (registered trademark) communication network or WiMAX (registered trademark).

The storage unit 140 is a functional unit in which various data usable for the operation of the content distribution device 10 is stored. The storage unit 140 is constituted by, for example, a solid state drive (SSD) as a semiconductor memory, a hard disk drive (HDD), or the like.

Here, distribution data management information 142 is stored in the storage unit 140. In addition, a content directory 144 in which a content 1442 is stored exists in the storage unit 140.

In the distribution data management information 142, information for managing distribution data distributed to the display device 20 (panel) is stored. The distribution data management information 142 stores a play list 1422, program information 1424, and display schedule information 1426. The program information 1424 and the display schedule information 1426 are generated as appropriate.

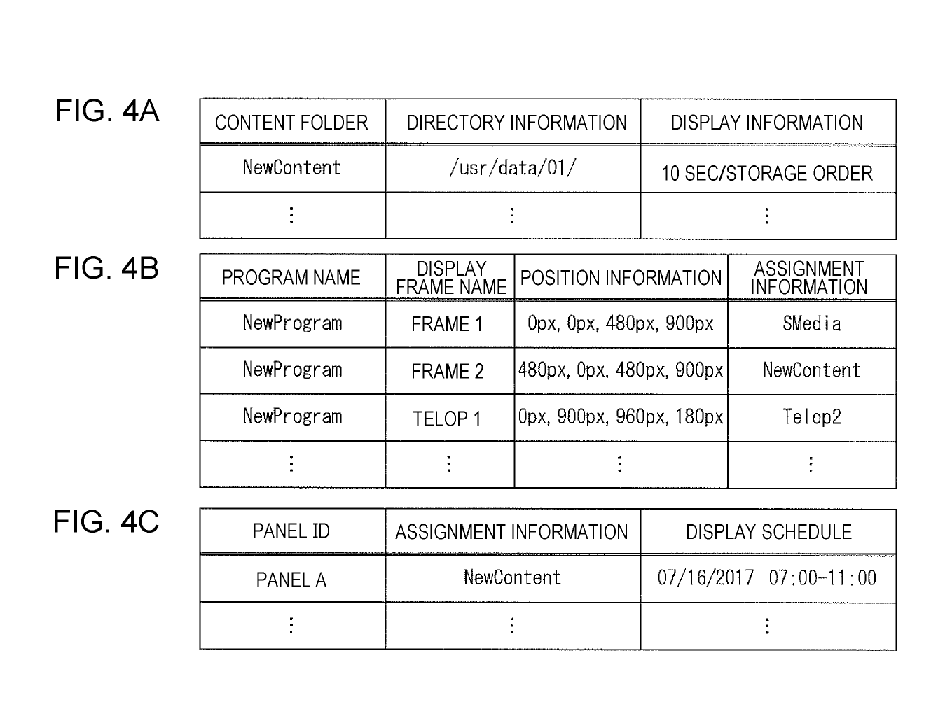

The play list 1422 is information for managing as a content folder a link of the directory storing the content distributable to the display device 20. As illustrated in FIG. 4A, the play list 1422 stores a content folder (for example, “NewContent”) as a name for uniquely identifying the information stored in the play list, directory information (for example, “/usr/data/01/”) indicating the directory of the content directory 144 in which the content is stored, and display information (for example, “every 10 sec/storage order”) indicating a display method and status of the content stored in the directory.

Although it is described that the display information is included in the play list 1422 in the present embodiment, the display information may be stored as a separate file. This display information may be stored in the location where the play list 1422 is stored or may be stored in the content directory 144. For example, the display information may be stored in the same directory as the content 1442 as display information.

The program information 1424 is information on a display frame (layout) indicating how the content folder and the content are displayed on the display device 20.

If an example of the program information 1424 is illustrated as in FIG. 4B, a program name (for example, “NewProgram”) for identifying a program, a display frame name for identifying a display frame (for example, “Frame 1”), position information (for example, “0 px, 0 px, 480 px, 900 px”, from the front, representing x coordinate, y coordinate, width, height) indicating the position and size of the display frame, and assignment information (for example, “NewContent” as a content folder) indicating a content or play list are stored. The position information is information in which the size of the display frame is specified. As described above, the position and the size of the display frame may be specified, or the absolute coordinates (for example, the coordinates of the upper left and the lower right coordinates of the display frame) may be specified.

The display schedule information 1426 is information indicating timing at which content or the like is displayed in accordance with the content, the content folder, and the program information. If an example of the display schedule information 1426 is illustrated as in FIG. 4C, assignment information (for example, “NewContent” indicating a content folder) indicating one of a content, a play list, and program information, and a display schedule (for example, “07/16/2017 07:00-11:00”) indicating a period during which the content and the like indicated by the assignment information are displayed on the display device 20 are stored.

The content directory 144 indicates a content storage area in the storage unit 140 of the content distribution device 10. That is, a directory is created as a location to store the content 1442. Then, the content 1442 (for example, a file indicating a content such as a moving image file or a still image file) is stored in the created directory (content directory 144).

The content directory 144 is created in the storage unit 140 of the content distribution device 10. For example, the storage unit 140 may be created in a built-in or external storage device (for example, SSD or HDD), or may be created on another file server or network attached storage (NAS). In addition, a directory may be created in an area on the cloud.

### 1.3.2 Display Device

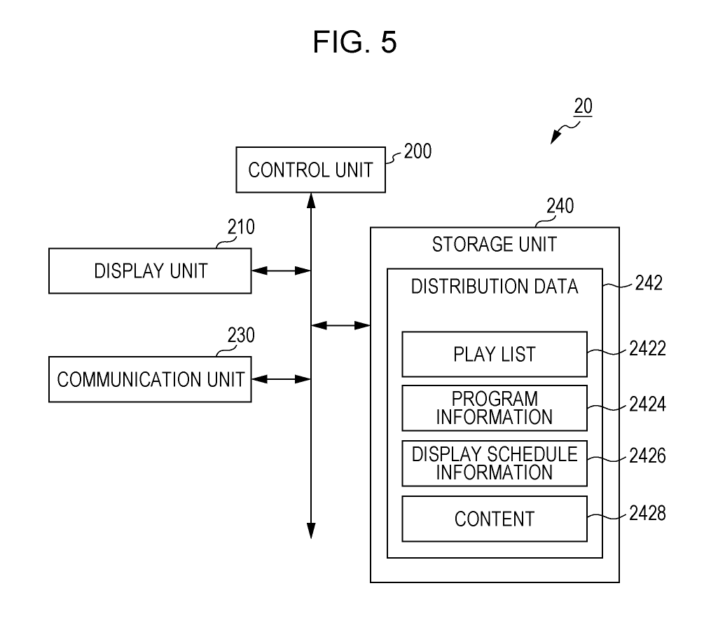

The functional configuration of the display device 20 in the present embodiment will be described with reference to FIG. 5. The display device 20 is a set of a system that performs actual display at an installation location as digital signage and is constituted by a control unit 200, a display unit 210, a communication unit 230, a storage unit 240.

The present embodiment will be described as the display device 20 but may be constituted by connecting a control device to a simple display panel with HDMI (registered trademark) or the like, for example. In addition, the present embodiment may be constituted as a single unit by the display device 20 equipped with a play function.

The control unit 200 is a functional unit for controlling the entire display device 20. The control unit 200 realizes various functions by reading and executing various programs stored in the storage unit 240 and is configured by, for example, a central processing unit (CPU) or the like.

The display unit 210 is a functional unit that displays contents based on distribution data 242 to be described later. For example, the display unit 110 is constituted by a liquid crystal display (LCD), an organic EL display (OLED), an LED screen or the like.

The communication unit 230 is a functional unit for communicating with other devices. For example, the communication unit 230 may be a functional unit that may communicate via a wired LAN or a functional unit that may communicate via a wireless LAN. The communication scheme may be Ethernet (registered trademark), IEEE802.11a/b/g/n, or a communication network such as LTE (registered trademark) communication network or WiMAX (registered trademark).

The storage unit 240 is a functional unit in which various data usable for the operation of the display device 20 is stored. The storage unit 240 is configured by, for example, a semiconductor memory (SSD), a hard disk drive (HDD), or the like. In addition, an external storage device such as a USB memory may be connected.

Here, distribution data 242 is stored in the storage unit 240. In addition, in the distribution data 242, a play list 2422, program information 2424, display schedule information 2426, and a content 2428 distributed from the content distribution device 10 are stored.

Distribution data distributed from the content distribution device 10 is stored as distribution data 242. Here, the play list 1422 distributed (transmitted) and received from the content distribution device 10 is stored in the play list 2422, the program information 1424 is stored in the program information 2424, and the display schedule information 1426 is stored in the display schedule information 2426, respectively.

In addition, the distribution data includes one or more contents. These contents are stored as the content 2428. The content 2428 may be stored as the distribution data 242 or may be stored in a directory that stores a predetermined content of the display device 20.

In addition, the play list, the program information, and the display schedule information are optional and are not necessarily included in the distribution data. In a case where there is such information, the content is displayed according to the information. However, even if these pieces of information are not included in the distribution data, for example, in a case where the program information (display layout) is not included, one content may be displayed on the full screen, or in a case where the display schedule information is not included, the content may be repeatedly displayed at every set time.

In addition, in a case where the content has already been distributed or the content stored in advance in the display device 20 is used, the content may not be included in the distribution data. In this case, the content stored in the display device 20 may be used in accordance with the play list, the program information, and the display schedule information.

That is, the information included in the distribution data may be distributed from the content distribution device 10 to the display device 20 as appropriate.

The display device 20, for example, may be constituted by a computer and a display, or may be integrated as a system. In addition, for example, the display device 20 may be realized by a display device such as a smartphone or a tablet.

### 1.4 Processing Flow

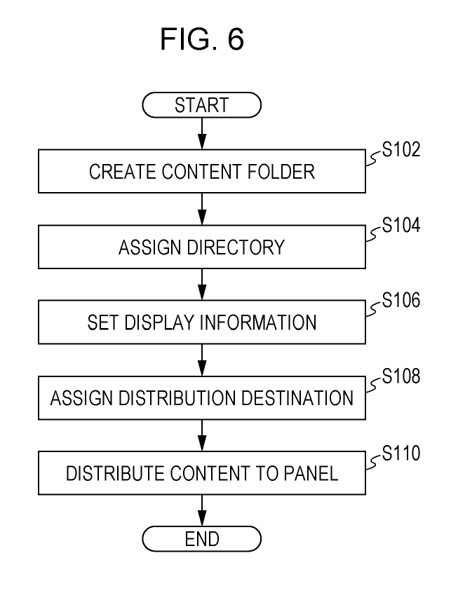

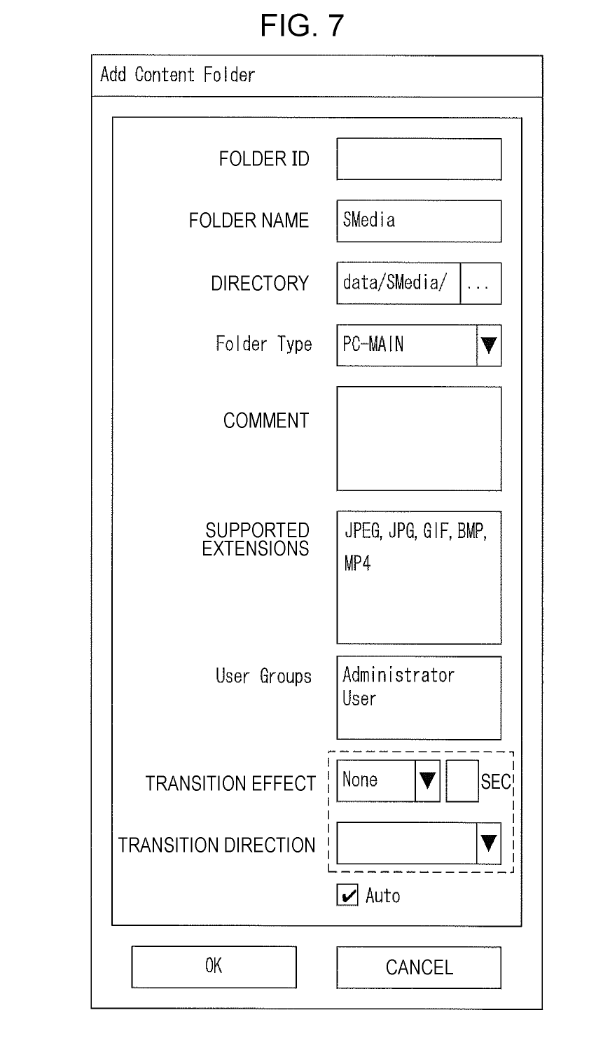

The flow of processing from creation of a content folder to assignment to a panel in the present embodiment will be described with reference to FIG. 6.

First, the content distribution device 10 creates a content folder (step S102). When a content folder is created, a directory is also assigned (step S104). In addition, display information is set as appropriate (step S106).

By executing the processing of steps S102 to S106, the play list 1422 is generated. Specifically, as the play list 1422, the name of the content folder and the information of the content directory 144 which is the link destination of the content folder are stored. Here, the content directory 144 may be assigned as a content folder.

For example, the content directory 144 may be assigned (linked) to a content folder that has already been created, or a content folder may be generated at the timing of assigning the content directory.

In addition, the content directory 144 may be created at the timing of being assigned to the content folder or may be assigned to a content folder that already exists.

In addition, display information may also be set as appropriate. As display information, for example, common display information may be set as an initial setting or may be set for each content folder. In addition, common display information and display information for each content folder may be set according to priority.

In addition, this display information may be stored as the play list 1422 or may be stored as a separate file. In addition, a file relating to display information already stored in the content folder may be used or the file may be output.

Subsequently, a display device 20 (panel) serving as a distribution destination is assigned (step S108). The processing here is processing of deciding a distribution destination by deciding to which display device (panel) the content folder is assigned.

As processing of determining a distribution destination, a plurality of processes is executed. Processing of simply determining the display device 20 to be distributed and processing of determining how to display on the display device are included.

First, in the processing of simply determining the display device 20 to be distributed, for example, a display device to which distribution data (content) is to be distributed is determined from the listed display devices 20. For example, an administrator may easily assign the content folder by selecting a display device as a distribution destination and dragging and dropping the content folder, the program, and the display schedule.

In addition, it is also possible to assign content folders and contents to programs and display schedules. That is, it is possible to specify where in the layout (one or more display frames) of the display screen in the display device 20 the content included in the content folder or the content itself is displayed. Furthermore, it is possible to generate a display schedule such as the output time, time, time zone, day of the week, date, and the like in the display device 20 and assign the content folder to the display schedule. The concrete processing thereof will be described as a separate embodiment.

Then, a content folder is specifically distributed to a panel (step S110). The content included in the content folder as distribution data is distributed to a panel (display device) determined as a distribution destination.

Here, as the timing at which distribution data is distributed (transmitted) from the content distribution device 10 to the display device 20, distribution data is distributed according to the distribution schedule. The distribution schedule may be, for example, a time set by the administrator or may be a preset time. In addition, the distribution schedule may be set and the distribution data may be distributed by the administrator performing a distribution operation at any timing.

In addition, the distribution schedule may be updated to the content folder at the timing when new content is added. For example, as the new content is added to the content folder, the distribution schedule is updated so that the distribution data is distributed to the display device 20 at the time of addition of new content or a next time of distribution.

In addition, as a method of distributing distribution data, there are a PUSH type in which the content distribution device 10 distributes distribution data to the display device 20 according to a distribution schedule or a distribution operation by an administrator, and a PULL type in which distribution data is distributed in response to a distribution request from the display device 20 to the content distribution device 10.

The display device 20 stores the distribution data transmitted from the content distribution device 10 and received as distribution data 242. Then, the content included in the distribution data 242 is stored as the content 2428. Then, the display device 20 appropriately refers to the play list 2422, the program information 2424, and the display schedule information 2426 included in the distribution data 242, reads the content 2428, and displays the content on the display unit 210.

### 1.5 Operation Example

The flow of the above-described processing will be described in detail by using examples of screens.

FIG. 7 is a diagram illustrating an example of a display screen for creating a content folder. As the content folder, for example, a content folder name, a content directory to be assigned, display information (for example, transition effect, transition direction, time, and the like) may be set. In addition, various settings are possible, for example, it is possible to set an extension of a supported content, an accessible group permission, and the like.

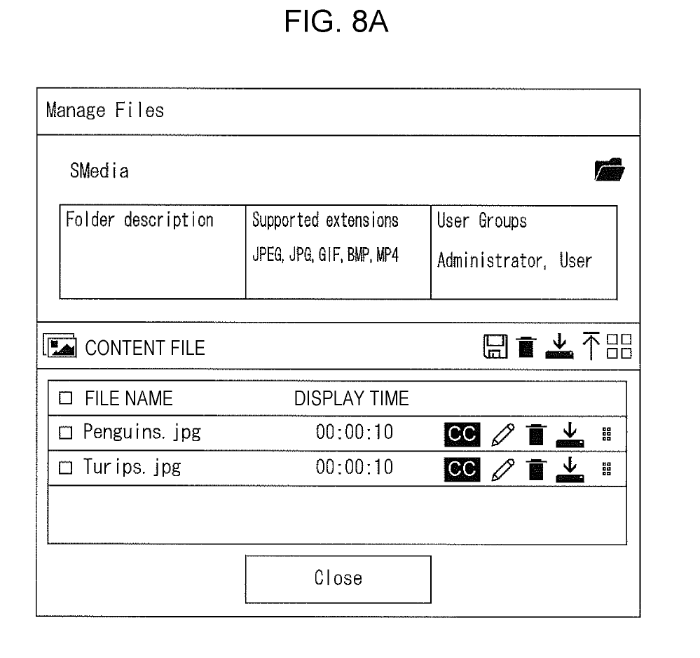

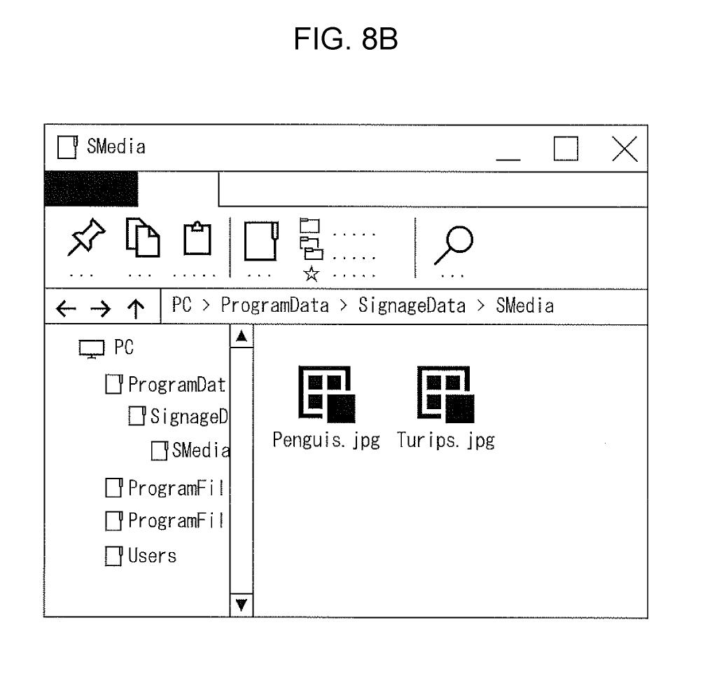

FIGS. 8A and 8B illustrate an example of a display screen on which a content is specifically assigned to a content folder. In FIG. 8A, information on the content folder is displayed on the upper side of the display screen. In addition, content files are listed on the lower side of the display screen. Here, FIG. 8B illustrates a screen displaying a content directory as a link destination of the content folder. On the screen illustrated in FIG. 8B, the content file assigned to the content folder is displayed. FIG. 8B may be, for example, a display screen of a general Windows folder.

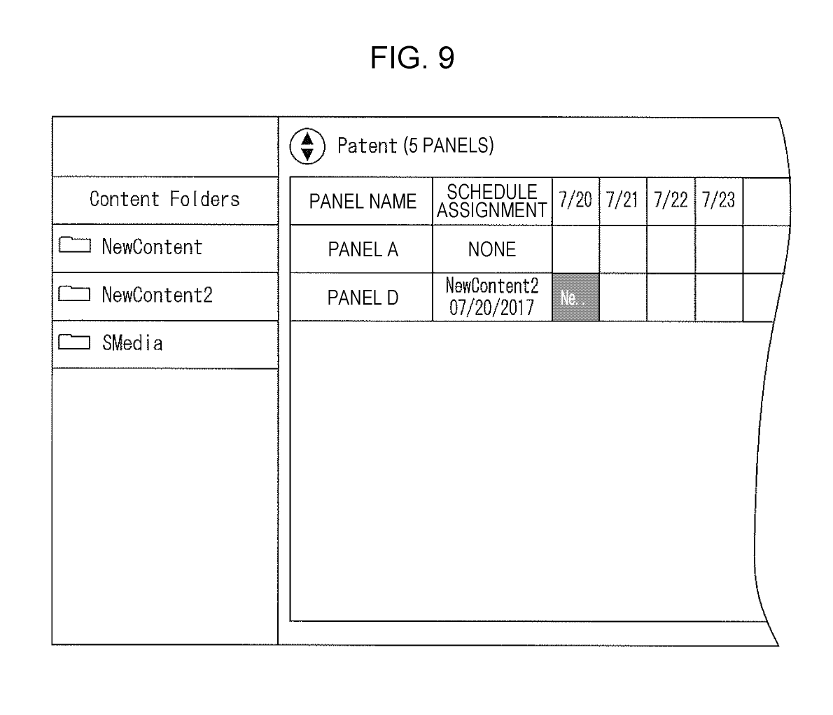

FIG. 9 is an example of a display screen for specifically assigning a content folder to a panel (the display device 20). On the left side of the display screen, a list of content folders is displayed, and on the right side, panels are listed. In the panels listed here, all panels included in the content distribution system may be displayed, or only panels extracted according to predetermined extraction conditions may be displayed. For example, in a case where the installation locations of the panels are stored, the panels may be displayed in a state (narrowed-down state) of being extracted by an installation location. In addition, for example, only panels that are in a distribution error or only panels selected as desired by the user may be displayed.

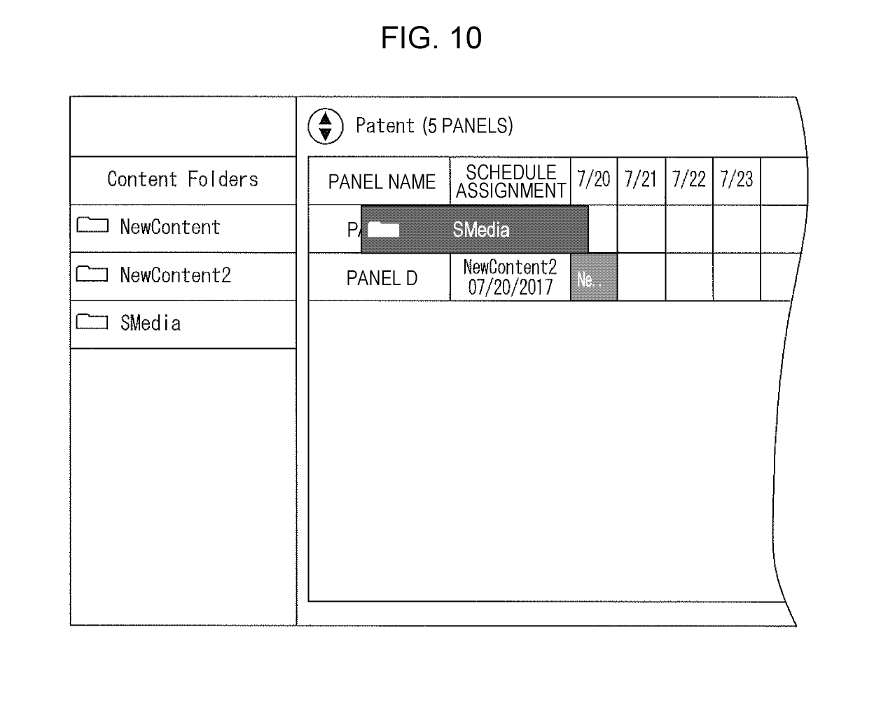

As illustrated in FIG. 10, the identification display of a content folder is selected with respect to the listed panels, and an operation of dragging and dropping the content folder onto the listed panels is executed. For example, in FIG. 10, a content folder “SMedia” is in a state of being dragged and moved to “Panel A”.

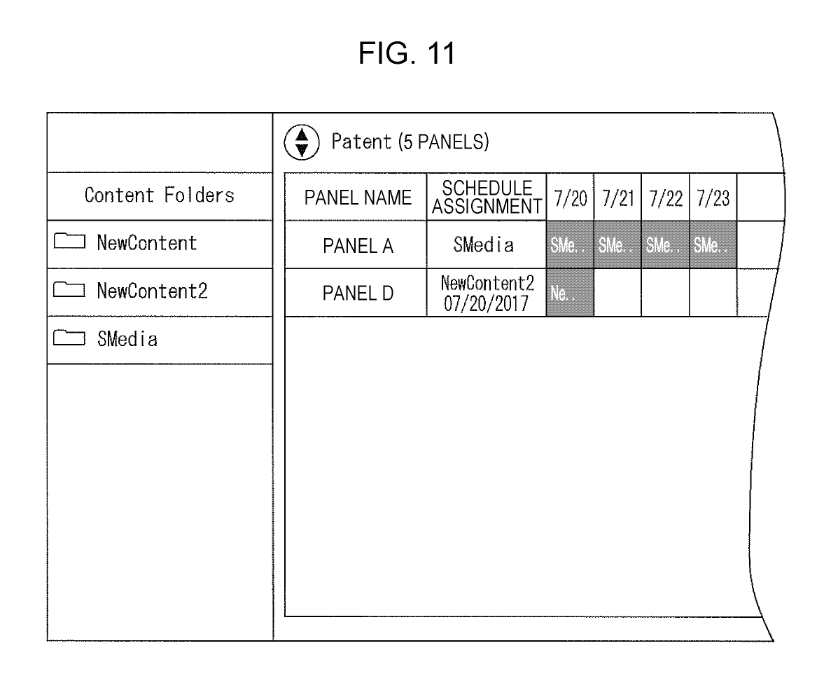

FIG. 11 illustrates the state in which the content folder is dropped on “Panel A”. In this way, it is possible to distribute the content folder to a desired panel (display device 20) by simply dragging and dropping the content folder.

Before dropping the content folder, the user may select the panel that the user wants to distribute. In a case where there is a previously selected panel, the dropped content folder is distributed to all selected panels.

In addition, in the screen example described above, the content folder is displayed and selected, but a program further assigned from the content folder or a display schedule may be dropped.

### 2. Second Embodiment

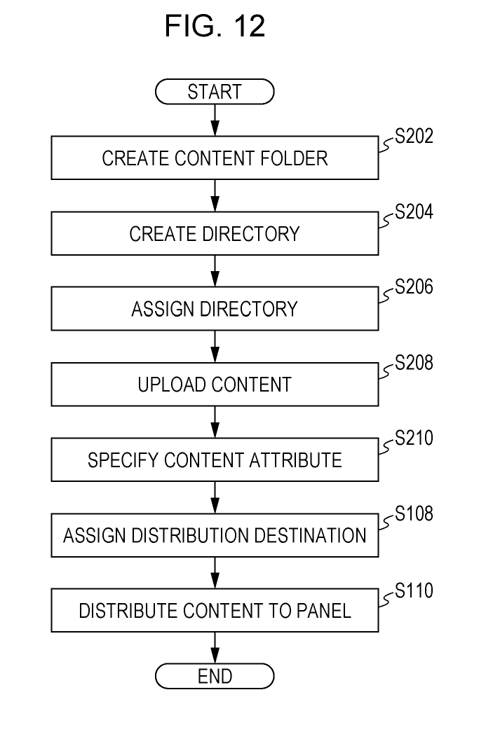

Subsequently, a second embodiment will be described. In the first embodiment, the case where a directory is assigned to a content folder has been described. In the present embodiment, the case where the administrator uploads a content by using the UI without directly manipulating a directory will be described. The system and the functional configuration are similar to those of the first embodiment, and the processing flow of FIG. 6 is replaced by the processing flow of FIG. 12. Identical processing is given the same reference numerals, and description thereof is omitted.

First, a content folder is created (step S202). Then, when a content folder is created, a content directory for storing a content is created (step S204), and the location of the created content directory is assigned to the content folder (step S206).

That is, the location of the content directory created on the system becomes the link of the location indicating the storage location of the content and is stored as the directory information of the play list 1422. In this case, in the storage unit 140 of the content distribution device 10, the administrator is not aware of where the content directory is created and where the location of the content directory is.

Here, the content may be uploaded (step S208), and the attribute of the content may be specified (step S210). Here, the attribute of the content includes display information such as a display time of the content, a display method, display permissions or the like.

In addition, as the attributes of the content, it is possible to set the display restriction information as information such as an expiration date, a display day of the content, and the like. The display restriction information includes information on a date, a period, a time, a day of the week, a week, and the like as a condition under which each content may be displayed (or may not be displayed).

The display information and the display restriction information may be set for each content but may be set for each content folder.

In addition, the display restriction information may be included in the play list 2422 or may be stored as another information. Furthermore, the display restriction information may be stored as a setting file in the content directory.

In the processing flow of FIG. 12, uploading of a content is described as an example, but other operations are of course possible. For example, contents may be moved, copied, deleted, renamed, and the like.

In addition, when uploading a content, the content may be converted into a file format that may be displayed on the display device 20. For example, in a case where a document file is uploaded, the document file may be converted into a file format that may be displayed, such as PDF file and PNG file, and in a case where a movie is uploaded, the movie may be converted by specifying a format that may be played or bit rate or may be converted automatically.

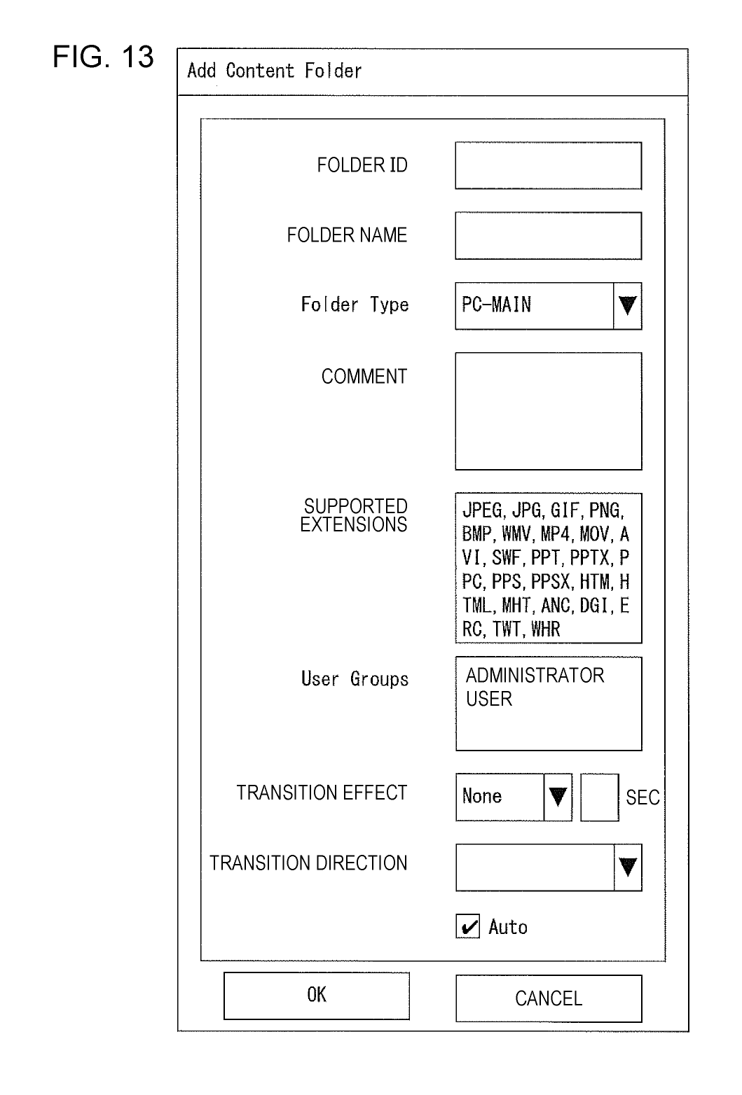

Subsequently, the operation of the present embodiment will be described by using an example of a display screen. FIG. 13 is an example of a display screen in the case of creating a content folder. A content folder name, a type of a content folder, a display attribute of a content folder, and the in the case of creating a content folder like may be input and set. A content folder is created based on these inputs and settings and a content directory to be assigned is created.

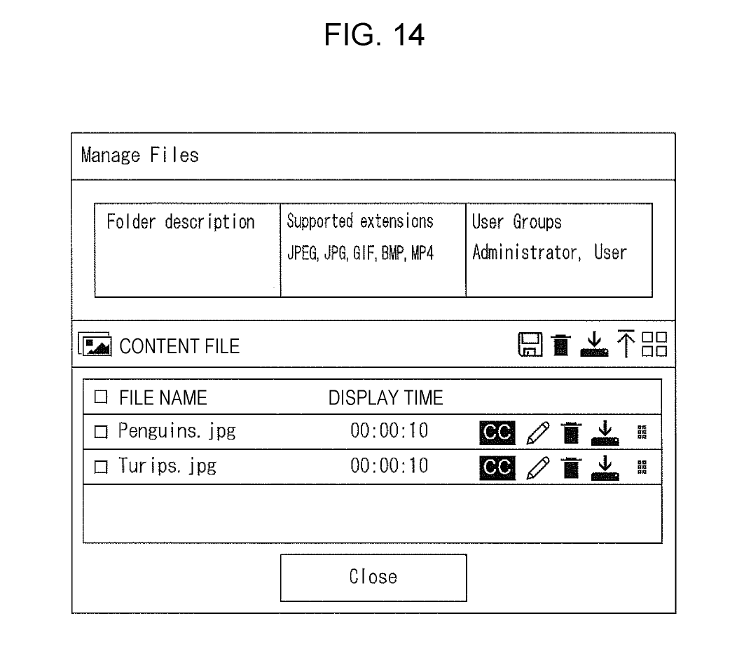

FIG. 14 illustrates a content management screen. From this screen, it is possible to upload (register) or delete contents as appropriate. In addition, it is also possible to download or display the contents in thumbnails as appropriate.

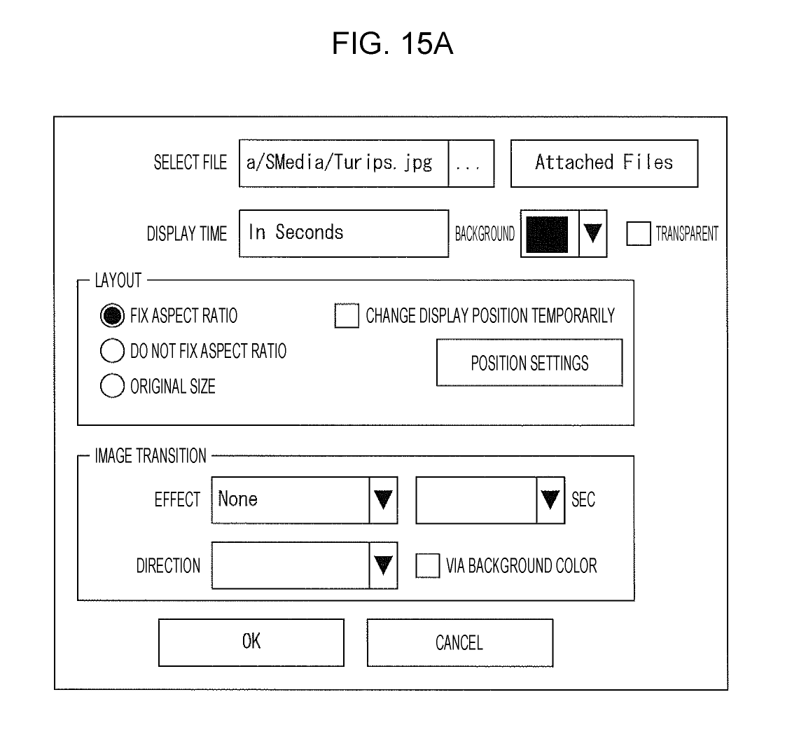

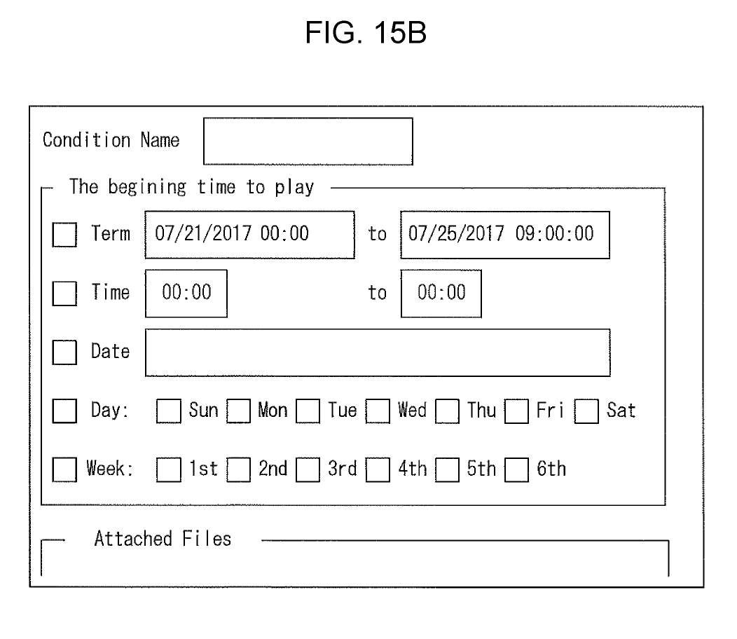

FIG. 15A is a screen for setting attributes of contents. A file (moving image file, audio file, text file, and the like) uploaded as a content may be selected.

In addition, attributes of a content may be set on this display screen. As the attributes of a content, various attributes may be set, but for example, display time, content background color, presence/absence of transparency, layout (for example, aspect ratio, display position, and the like), screen transition (for example, time, effect, direction, background color, and the like) may be set.

In this way, in the present embodiment, it is possible to easily manage the contents by using the UI. In addition, it is also possible to easily set an attribute for each content.

In addition, as the display attribute of the content, for example, as illustrated in FIG. 15B, display restriction information (for example, expiration date and display condition) may be set for each content. According to FIG. 15B, for example, it is possible to specify the time (expiration date), day of the week, week, and the like at which each content may be displayed. Thus, it is possible to display a content for a limited period of time or not to display the content after the period has elapsed.

In the first embodiment, the content directory is directly manipulated, but may be switched to a content directory that is manipulated by using the UI of the second embodiment.

### 3. Third Embodiment

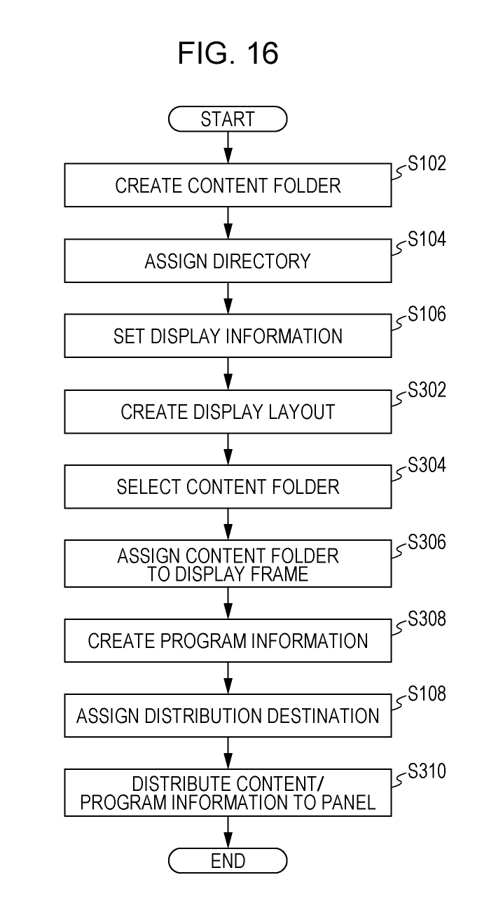

Subsequently, a third embodiment will be described. In the third embodiment, not only a content folder but also program information is assigned to the display device 20. The system and the functional configuration are similar to those of the first embodiment, and the processing flow of FIG. 6 is replaced by the processing flow of FIG. 16. Identical processing is given the same reference numerals, and description thereof is omitted.

In steps S102 to S106, a content folder is created and set. Subsequently, a display layout is generated as program information (step S302).

The display layout is provided for setting how the content is displayed on the display device 20. For example, it is possible to divide the display screen into areas of two or more display frames and assign content folders (contents) to the respective areas.

For this purpose, firstly, a display frame is generated as a display layout. The display frame may be the absolute coordinate of the display screen in the display device 20 or the size of the display frame from a certain coordinate. In addition, for example, the display frame may be specified to be divided into two right and left.

Then, a content folder is selected (step S304), and the selected content folder is assigned to a display frame (step S306). Two or more content folders may be assigned to one display frame, or the same content folder may be assigned to different display frames. In addition, instead of content folders, contents may be assigned directly.

Then, the display layout (display frame information) and the information on the assigned content folder and content are generated as program information (step S308). Then, the content folder, the content, and the program information are assigned to the display device 20 selected as the distribution destination (step S108), and the content (content folder) and the program information are distributed to the display device 20 (panel) (step S310).

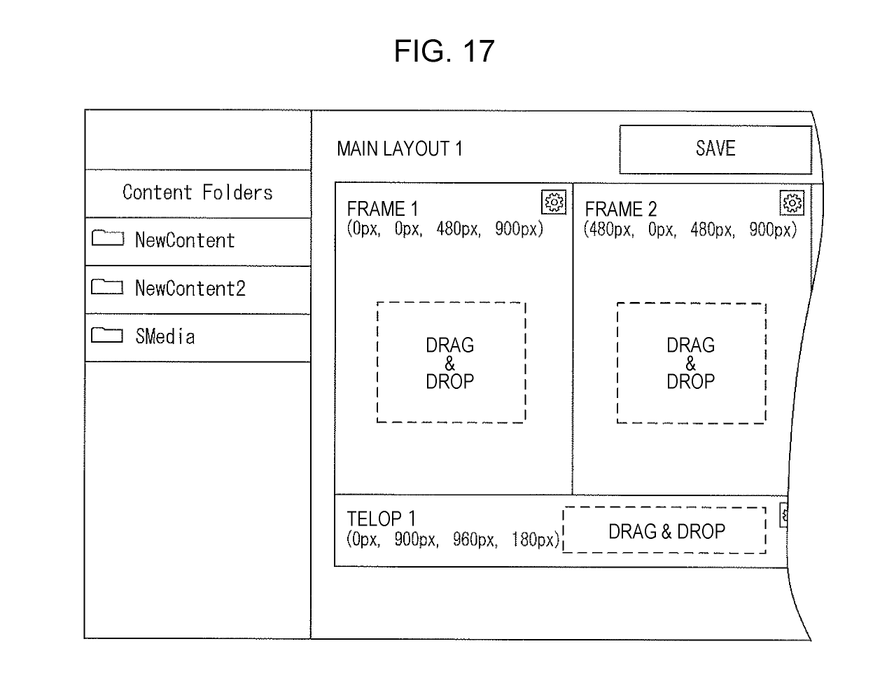

Subsequently, the operation of the present embodiment will be described by using an example of a display screen. FIG. 17 illustrates an example of a display screen on which a display layout is set. “Main Layout 1” is a screen set as the display layout, for example, a display frame such as frame 1, frame 2, . . . , and a display frame such as telop 1 are set.

There may be plural kinds of these display frames. For example, in the display frame of a frame, any content (content folder) is assigned, but in the display frame of a telop, only the content of the text information may be assigned.

In addition, the setting of these display frames may be based on a setting file or may be set by the UI. In addition, attributes, (for example, display information for specifying a switching timing and the like of a content, display/non-display, and the like) may be set for each display frame.

In the display screen of FIG. 17, a list of content folders is displayed on the left side. Here, a display for identifying a content folder may be dragged and dropped from a display field of the content folder to the display frame. Thus, it is possible to easily assign the content folder to the display frame.

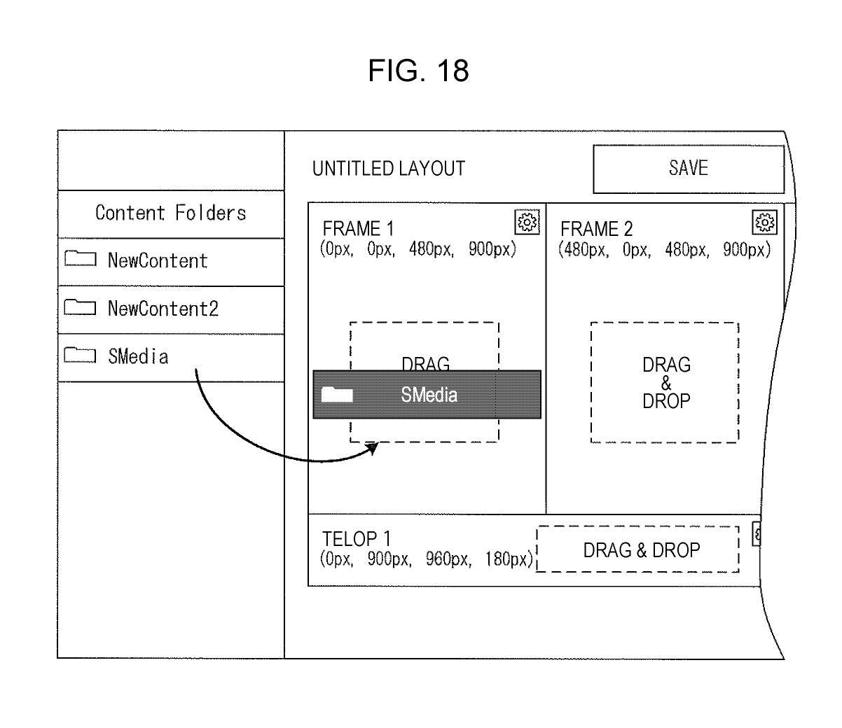

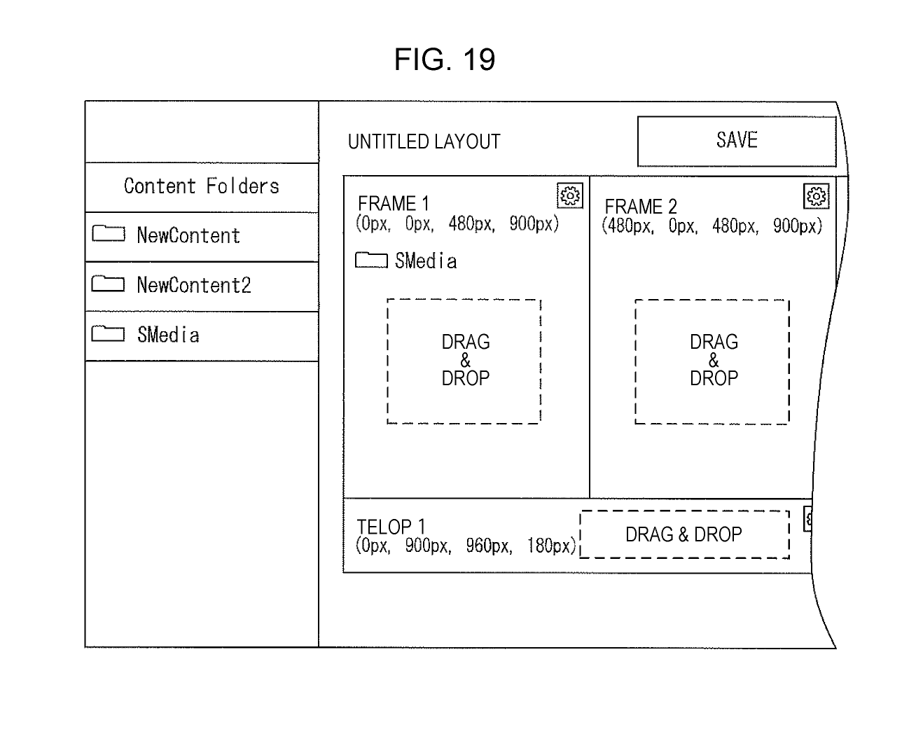

That is, it is possible to easily assign a content folder to the frame 1 (FIG. 19) by dragging and dropping the content folder of the content folder “SMedia” onto the display frame of the frame 1 (FIG. 18).

By utilizing the display layout, it is possible to operate digital signage flexibly. For example, it is possible to assign common content to one display frame and assign individual contents to other display frames. For example, in a case where the display screen is used in a large shopping center, it is possible to use a method of displaying contents common to all stores in one display frame and displaying contents of each store in another display frame.

In addition, it is also possible to display contents of stores in one display frame and display contents such as weather forecast and news in different display frames.

### 4. Fourth Embodiment

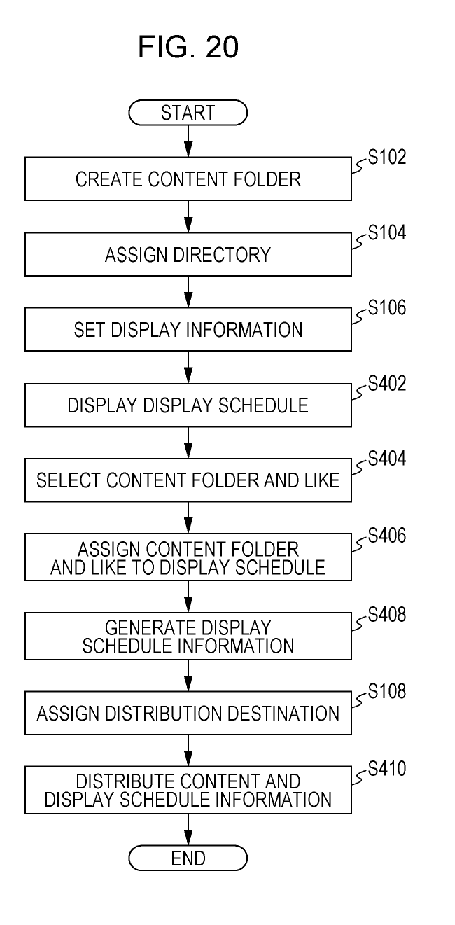

Subsequently, a fourth embodiment will be described. In the fourth embodiment, not only a content folder but also a display schedule is assigned to the display device 20. The system and the functional configuration are similar to those of the first embodiment, and the processing flow of FIG. 6 is replaced by the processing flow of FIG. 20. Identical processing is given the same reference numerals, and description thereof is omitted. In addition, the program information described in the third embodiment may be assigned to the display schedule.

In steps S102 to S106, a content folder is created and set. Subsequently, a display schedule is displayed (step S402). Here, various methods may be considered as a display method of the display schedule. For example, display methods such as a weekly display, a monthly display, and the like may be considered as well as displaying the display schedule at a specified date. In addition, as a display format, not only a list display but also a method such as a calendar display may be considered. In addition, the display schedule may be not only in a calendar format such as a daily display, a weekly display, or a monthly display, but also a method of displaying two or more display devices 20 collectively or displaying the display devices 20 in accordance with the contents may be considered.

Subsequently, a content folder or the like is selected (step S404), and a content folder or the like is assigned to the display schedule (step S406). Here, the content folder or the like assigned to the display schedule includes not only the content folder but also the content itself and the program to which the content folder is assigned. In addition, as a method of assigning a content folder or the like to a display schedule, a display such as a content folder may be dragged and dropped in a calendar display or the like, or a display schedule may be registered for each content folder or the like.

In this manner, display schedule information in which content folders and the like are assigned to the display schedule is generated (step S408). Then, a distribution destination is assigned (step S108), and contents (content folder, program, and the like) and display schedule information are distributed as distribution data to the display device 20 according to the distribution schedule.

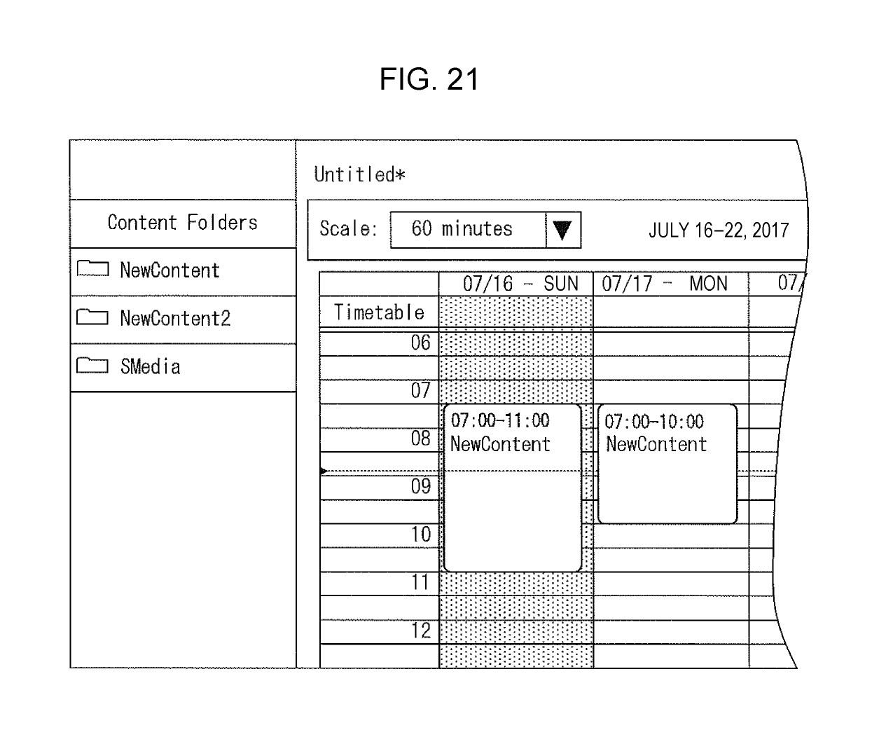

FIG. 21 illustrates an example of a display screen. A list of content folders is displayed on the left side of the display screen, and a display schedule is displayed on the right side. The display schedule of FIG. 21 is a display schedule in a weekly display, which is displayed so that date and time are shown. In addition, for each date, the name of the content folder to be displayed or the like is displayed.

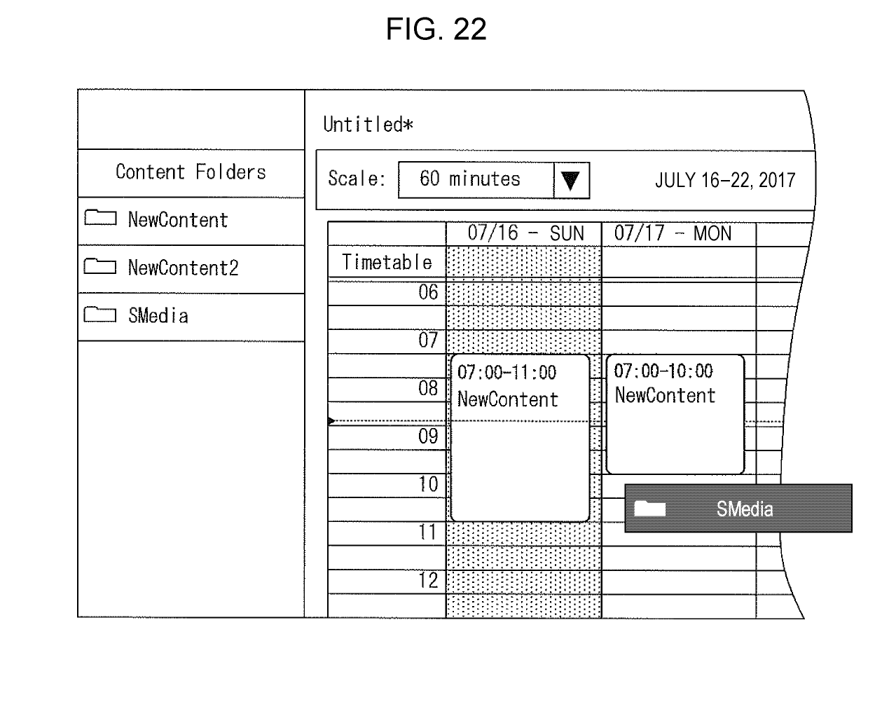

Here, in a case where it is desired to assign a content folder to the display schedule, the content folder displayed on the left side is dragged and moved to the display schedule area (FIG. 22).

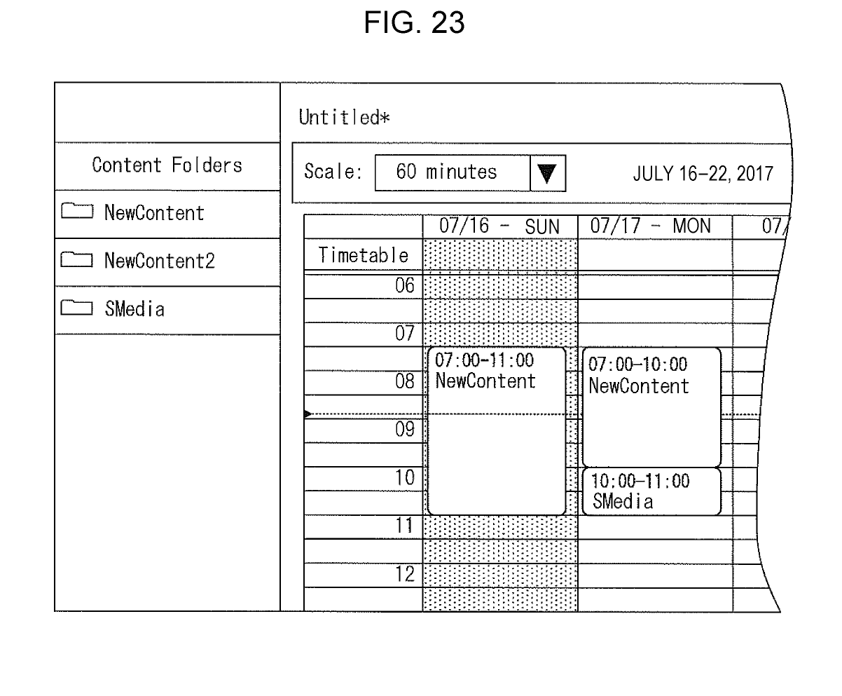

Then, a content folder is assigned to the display schedule by dropping the dragged content folder in the time zone in which the content folder is to be actually displayed (FIG. 23).

In this way, according to the present embodiment, the administrator may easily specify distribution of contents by using the display screen of the display schedule. In addition, in the case of specifying a content to be distributed, it is possible to assign a content folder to the display schedule by using the UI.

Therefore, it is possible to intuitively distribute the content to the display device 20 by using the UI without generating the display schedule information as a separate file as before by the administrator.

### 5. Screen Application Example

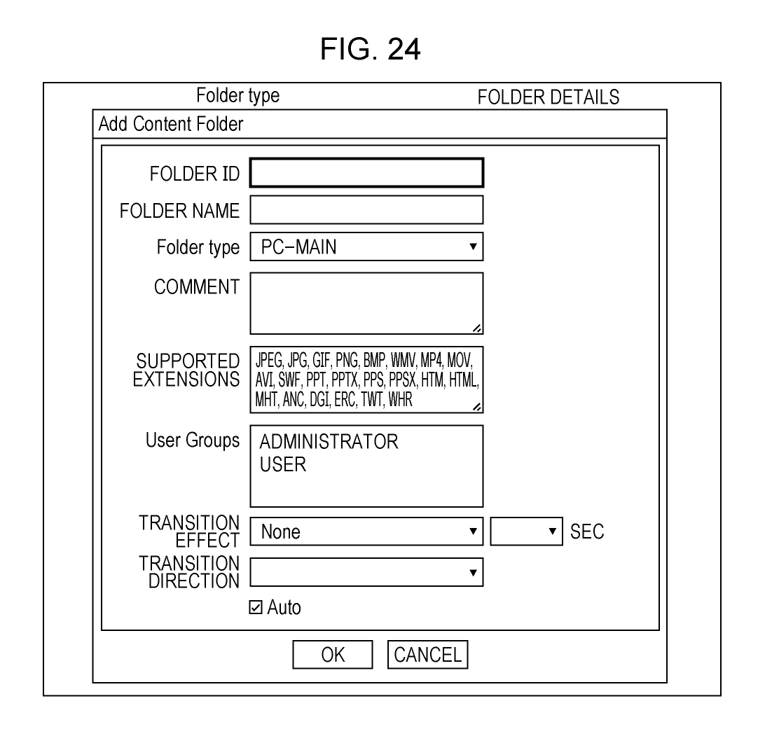

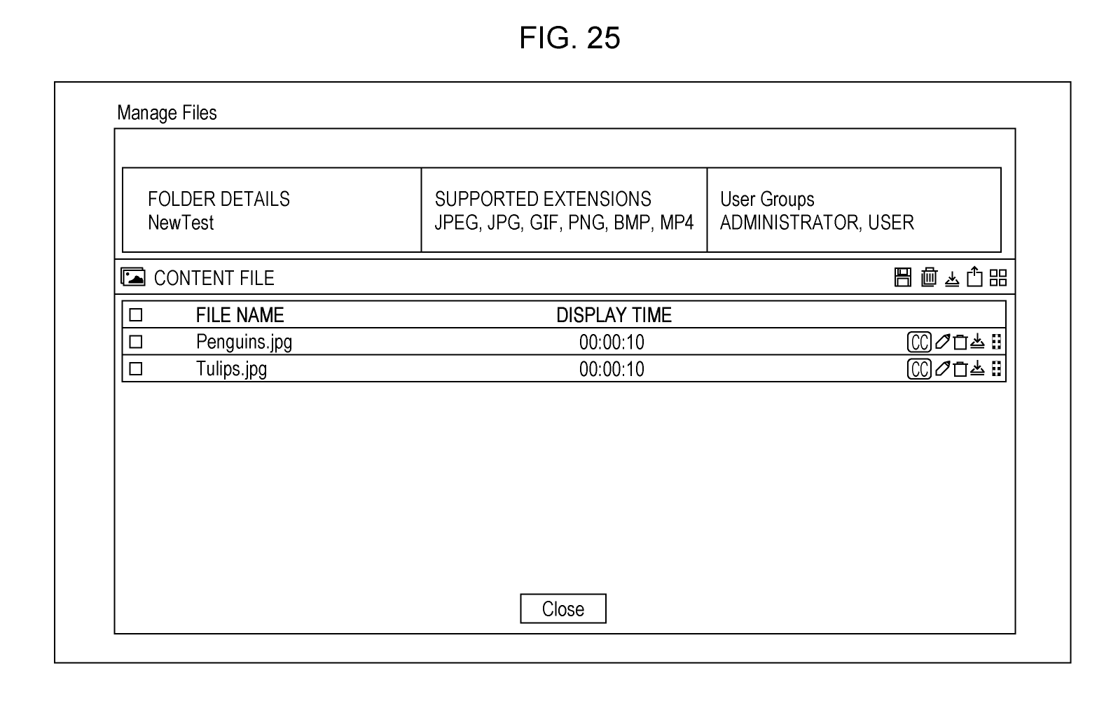

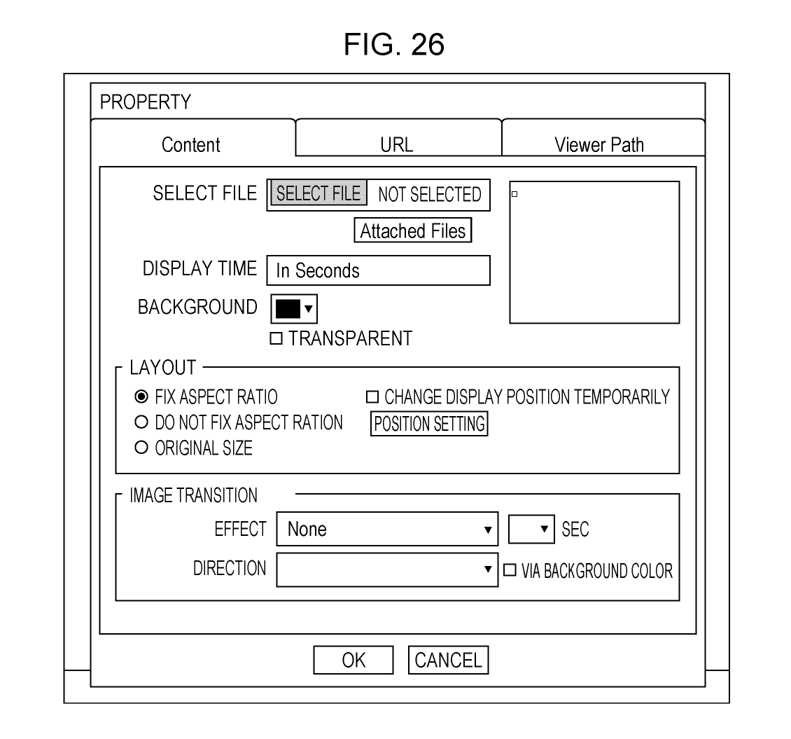

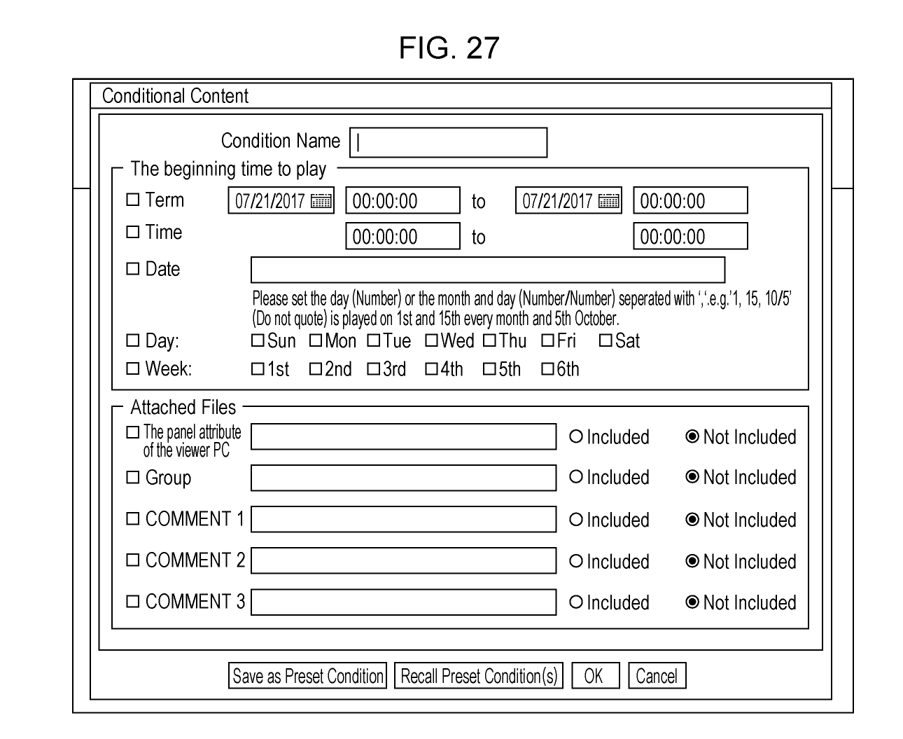

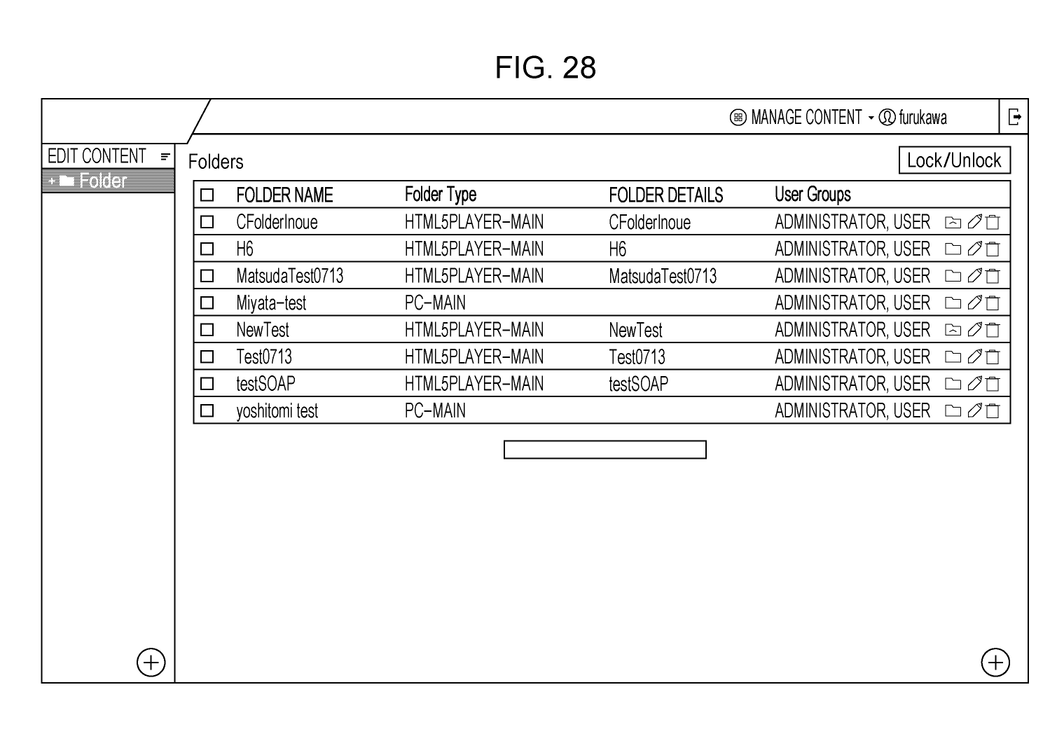

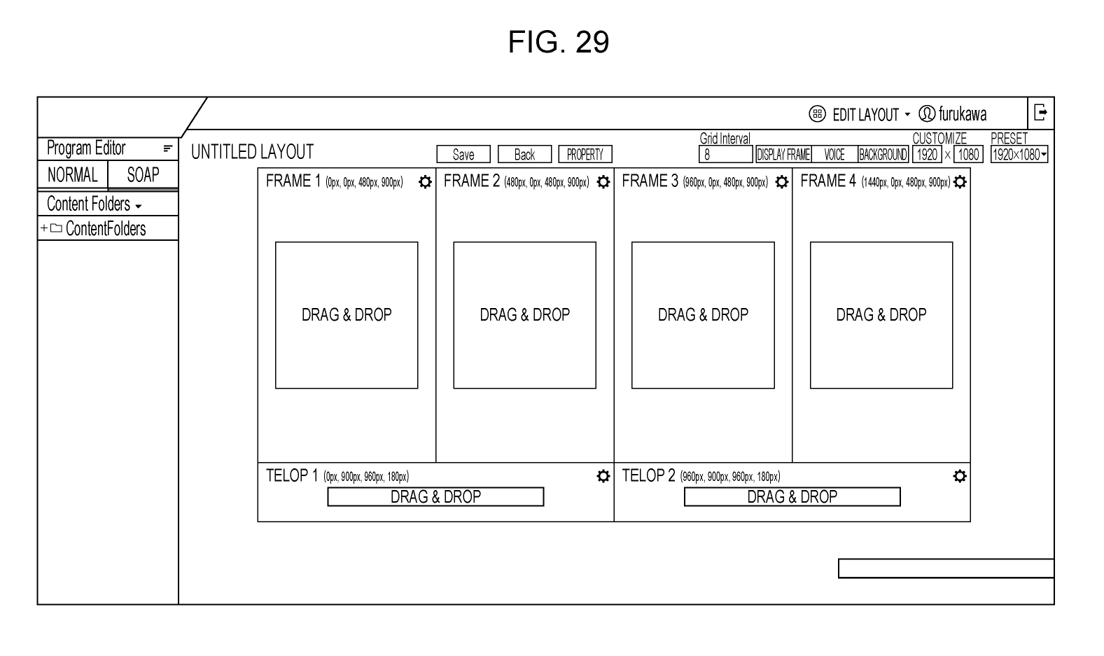

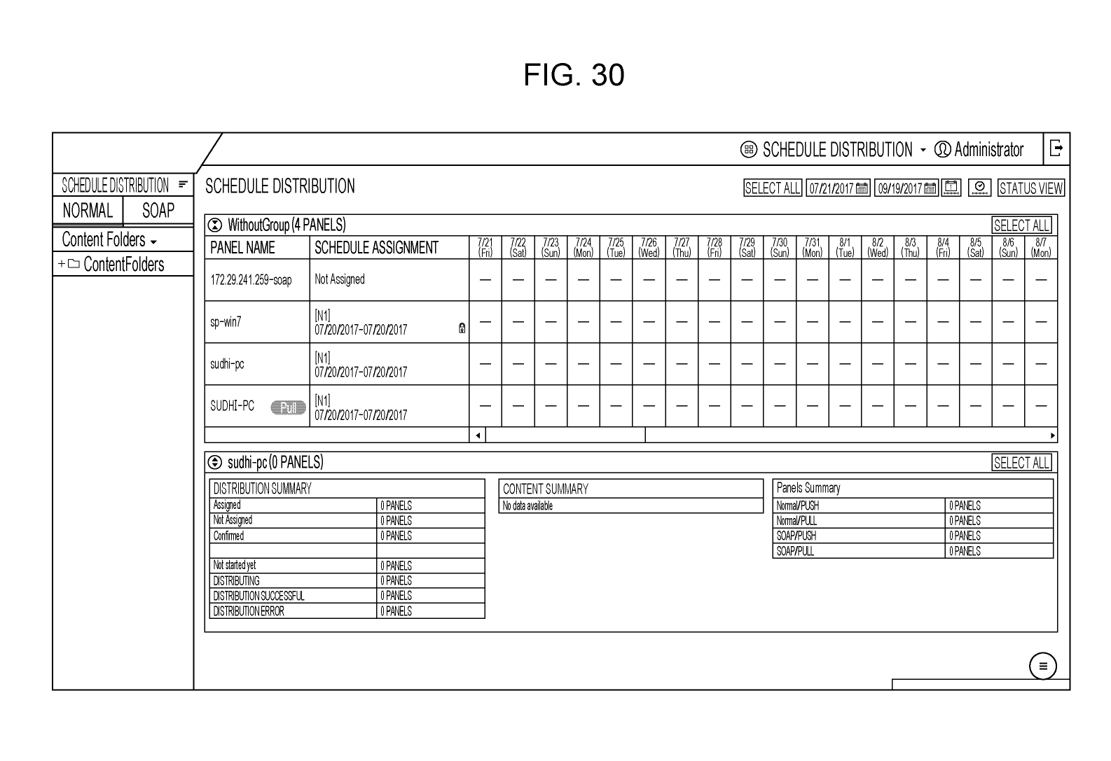

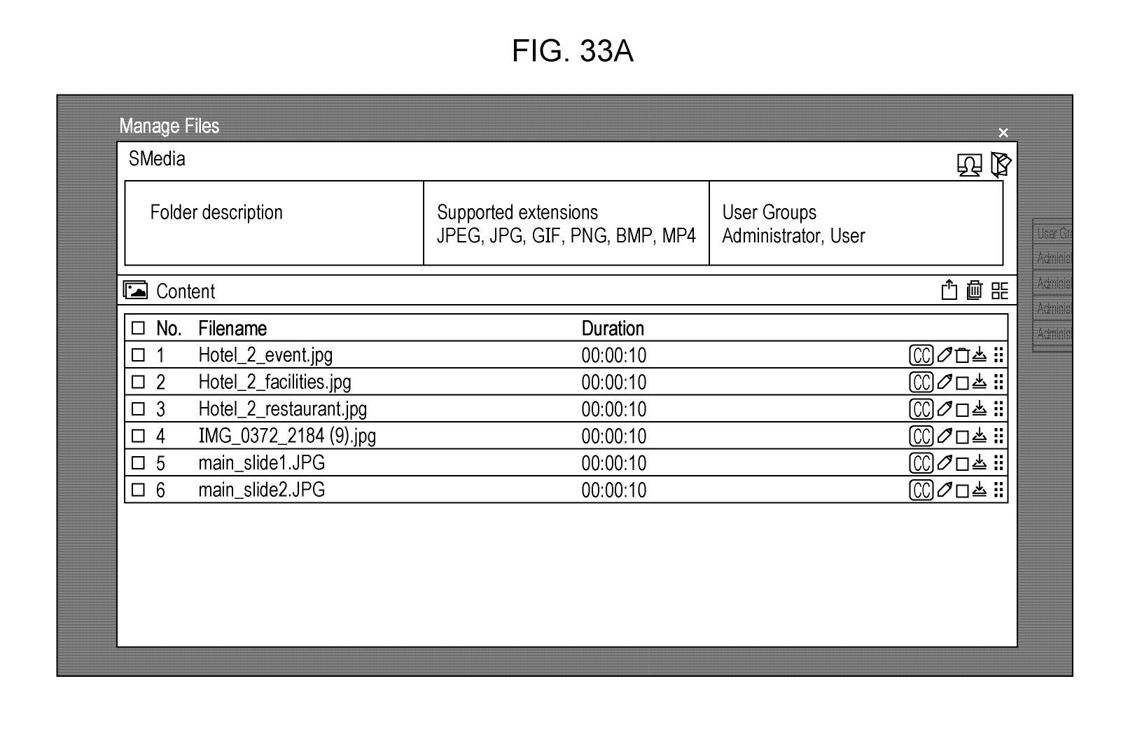

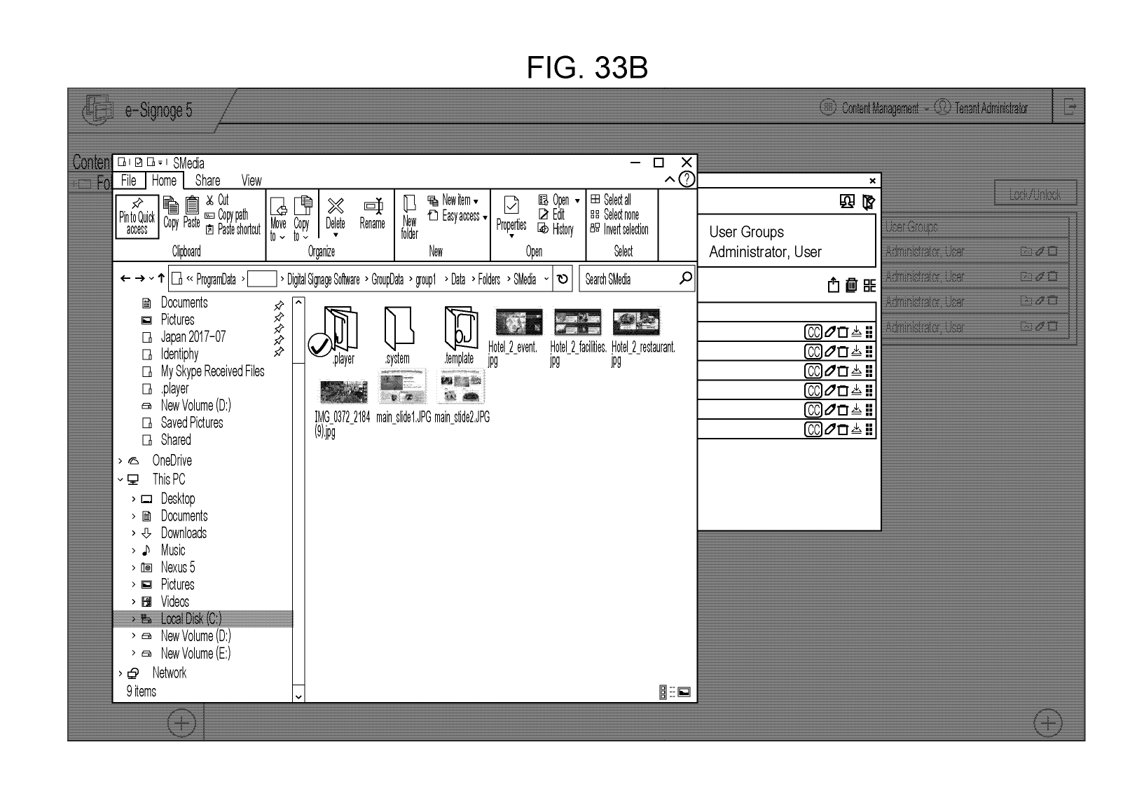

FIGS. 24 to 33B illustrate examples of screens in a case where the above-described embodiment is actually operated. FIGS. 24 to 33B are examples of screens in a case where the processing of the above-described embodiment is specifically executed on the content distribution device 10. FIG. 24 is a diagram illustrating a screen of creating a content folder, FIG. 25 is a diagram illustrating a screen of uploading, FIG. 26 is a diagram illustrating a screen of content attribute settings, FIG. 27 is a diagram illustrating setting of display restriction information, FIG. 28 is a diagram illustrating a screen of a content folder list, FIG. 29 is a diagram illustrating a screen of creating a display layout, FIGS. 30 to 32B are diagrams illustrating screens of assigning a content folder, and FIGS. 33A and 33B are diagrams illustrating a screen of assigning a directory.

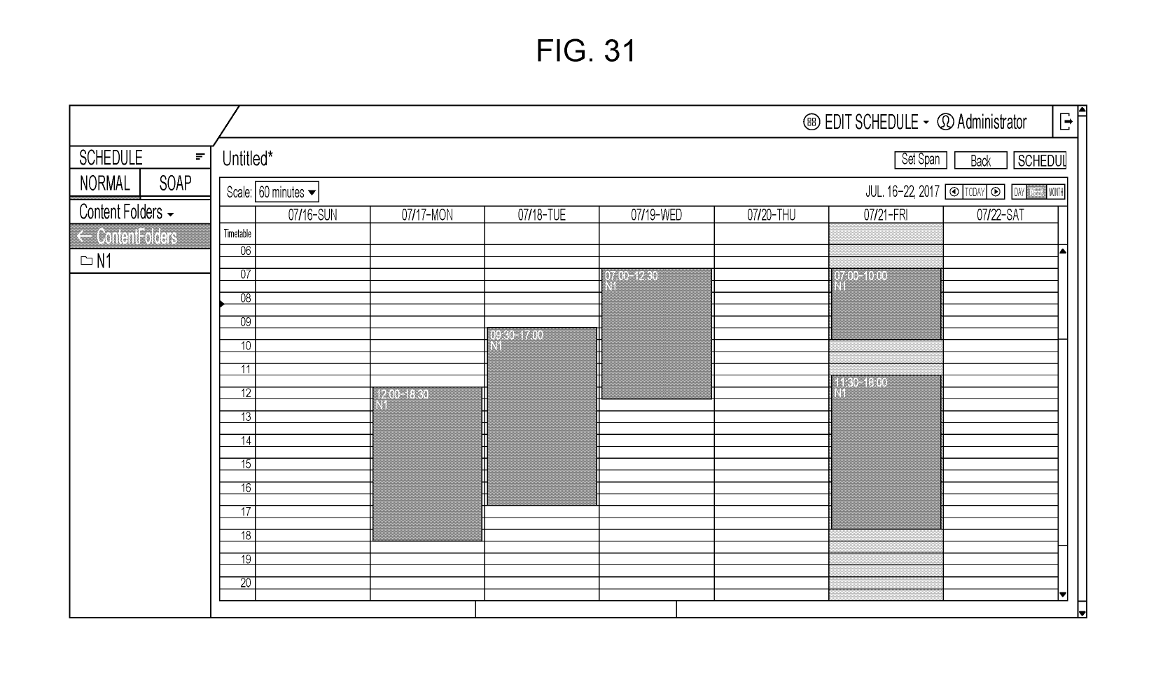

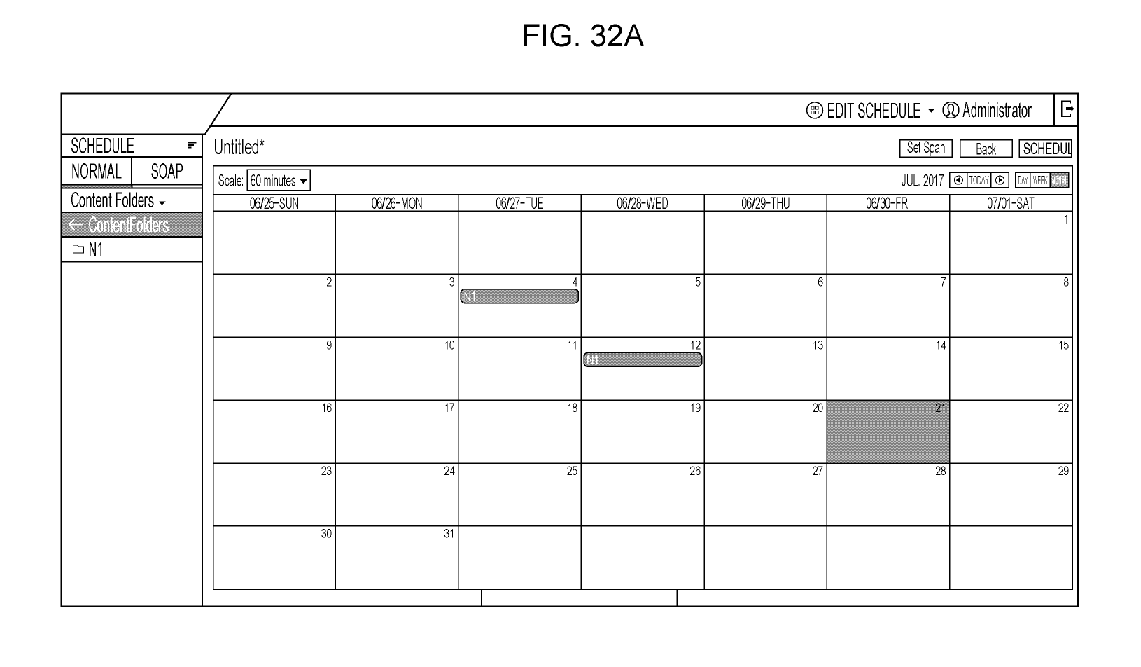

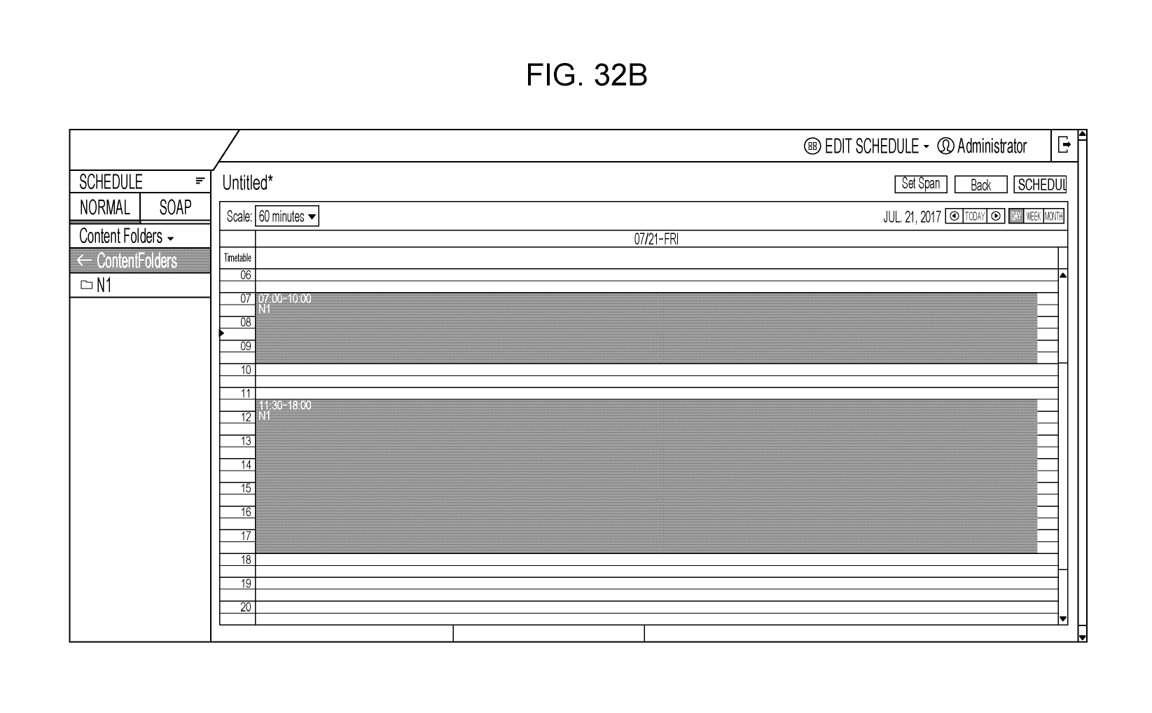

For examples of screens of assigning a content folder, FIG. 30 illustrates an example of a screen of assigning a content folder to the panel described in the first embodiment, and FIG. 31 is an example of a screen of assigning a content folder to the display schedule described in the fourth embodiment. In addition, FIG. 31 illustrates the assignment status of the content folder in a weekly display (7 days) but may be in a monthly display as in an example of a screen of FIG. 32A or a daily display as in an example of a screen of FIG. 32B, and buttons and the like for switching these screens are displayed on the screens. In addition, FIG. 33A illustrates a display screen of a content file assigned to a content folder, and FIG. 33B is a screen displaying the content directory to be a link destination of the content folder.

### 6. Modification Example

The embodiments of the present disclosure have been described in detail with reference to the drawings, but the specific configuration is not limited to this embodiment, and designs and the like within the scope not deviating from the gist of the present disclosure are also included in the scope of the claims. In addition, for the sake of convenience of description, each embodiment has been described separately for the purpose of description, but it is possible to combine and execute the embodiments within a possible range.

In addition, in the embodiments, a program operating on each device is a program (a program that enables a computer to function) for controlling a CPU or the like so as to realize the functions of the above-described embodiments. Information handled by these devices is temporarily stored in a temporary storage device (for example, RAM) at the time of processing, then stored in the storage devices of various ROMs, HDDs and SSDs, and read, modified and written by the CPU as appropriate.

In addition, in the case of distributing to the market, the program may be stored in a portable storage medium and distributed or transferred to a server computer connected via a network such as the Internet. In this case, of course, the storage device of the server computer is also included in the present disclosure.

The present disclosure contains subject matter related to that disclosed in Japanese Priority Patent Application JP 2017-161407 filed in the Japan Patent Office on Aug. 24, 2017, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A content distribution device connectable to a display device that displays a content, the content distribution device comprising:
a management unit that manages, as a content folder, the content to be distributed to the display device;
a directory assignment unit that assigns a directory in which the content is stored to the content folder; and
a content distribution unit that distributes, to the display device, the content stored in the directory assigned to the content folder.

2. The content distribution device according to claim 1,
wherein display information indicating at least one of a display order, a display time, and a display position at the time of displaying the content by the display device is managed in the content folder, and
the content distribution unit distributes the display information together with the content.

3. The content distribution device according to claim 2,
wherein the display information includes information on one or more display frames as a display layout on the display device, and
the content distribution device further comprises a display frame assignment unit that assigns the content folder to the display frame.

4. The content distribution device according to claim 1,
wherein the management unit further manages display restriction information as information with which the display device displays or does not display the content.

5. The content distribution device according to claim 1, further comprising:
a distribution schedule generation unit that generates a distribution schedule for distributing the content to the display device,
wherein the content distribution unit distributes the content to the display device in accordance with the distribution schedule or distributes the content to the display device in a case where there is a distribution instruction.

6. The content distribution device according to claim 5,
wherein the distribution schedule generation unit adds the content to the distribution schedule in a case where the content is stored in the directory.

7. A content distribution device connectable to a display device that displays a content, the content distribution device comprising:
a management unit that manages the content as a content folder;
a directory assignment unit that assigns a directory in which the content is stored to the content folder;
a program information generation unit that generates program information indicating a layout for displaying the content on the display device in accordance with the content folder;
a display schedule information generation unit that sets a display schedule for displaying the content on the display device and generates display schedule information in accordance with the content folder or the program information;
a display device assignment unit that assigns distribution data including the content to the display device in accordance with any one of the content, the content folder, the program information, and the display schedule information; and
a distribution unit that distributes the distribution data assigned by the display device assignment unit to the assigned display device.

8. A content distribution system comprising:
a display device that displays a content; and
a content distribution device connectable to the display device,
wherein the content distribution device includes
a management unit that manages, as a content folder, a content to be distributed to the display device;
a directory assignment unit that assigns a directory in which the content is stored to the content folder; and
a content distribution unit that distributes, to the display device, the content stored in the directory assigned to the content folder, and
wherein the display device includes
a content reception unit that receives the content distributed from the content distribution device, and
a content display unit that displays the received content.

9. A non-transitory storage medium storing a program causing a computer connectable to a display device that displays a content to execute:
a management function of managing, as a content folder, the content to be distributed to the display device;
a directory assignment function of assigning a directory in which the content is stored to the content folder; and
a content distribution function of distributing, to the display device, the content stored in the directory assigned to the content folder.
